(19) United States
(12) Patent Application Publication
(10) Pub. No.: US 2024/0203068 A1
(43) Pub. Date: Jun. 20, 2024

(54) METHOD AND SYSTEM FOR PROVIDING AUGMENTED REALITY OBJECT BASED ON IDENTIFICATION CODE

(71) Applicant: VIRNECT CO., LTD., Seoul (KR)

(72) Inventors: Ki Young KIM, Seoul (KR); Noh Young Park, Paju-si (KR)

(21) Appl. No.: 18/539,662

(22) Filed: Dec. 14, 2023

(30) Foreign Application Priority Data
Dec. 14, 2022 (KR) 10-2022-0174721
Dec. 16, 2022 (KR) 10-2022-0177280
Dec. 16, 2022 (KR) 10-2022-0177282
Dec. 16, 2022 (KR) 10-2022-0177285

(51) Int. Cl. G06T 19/00; G06F 3/0346

(52) U.S. Cl. CPC G06T 19/006; G06F 3/0346

(57) ABSTRACT

A method for providing an AR object based on an identification code by a tracking application executed by at least one processor of a terminal according to the present disclosure comprises generating an AR library, which is a data set providing a predetermined augmented reality environment, based on at least one or more target objects; storing the AR library by matching the AR library to a first target object and a second target object; and providing an augmented reality environment based on the second target object and the AR library matched to the first target object when being connected to the web environment based on the first target object, wherein providing an augmented reality environment comprises obtaining a first image capturing the first target object through an image sensor of the terminal, detecting the first target object based on the obtained first image, obtaining an augmented reality web environment access link for providing the AR library matched to the detected first target object, obtaining a second image capturing the second target object through an image sensor of the terminal in the augmented reality environment accessed through the obtained link, detecting a second target object based on the obtained second image, and controlling a first virtual object included in the AR library to be augmented and displayed on the detected second target object.

### CROSS-REFERENCE TO RELATED APPLICATIONS

This application claims the priority of the Korean Patent Applications, NO 10-2022-0174721, filed on Dec. 14, 2022, NO 10-2022-0177285, filed on Dec. 16, 2022, NO 10-2022-0177282, filed on Dec. 16, 2022, and NO 10-2022-0177280, filed on Dec. 16, 2022, in the Korean Intellectual Property Office. The entire disclosures of all these applications are hereby incorporated by reference.

### TECHNICAL FIELD

The present disclosure relates to a method and a system for providing an augmented reality (AR) object based on an identification code. More specifically, the present disclosure relates to a method and a system for providing a predetermined AR object through the web environment based on an identification code attached to an actual object.

### BACKGROUND

Augmented Reality (AR) technology may provide a variety of information by overlaying computer-generated graphics (virtual images) onto images which are actually shooted videos.

Here, the computer-generated virtual images may include images in which visual or non-visual information, is registered to the location of the subject, such as a 3D object or text information related to a specific subject.

To implement augmented reality, spatial registration between real images and virtual images is essential.

For this purpose, conventional methods utilize various authoring tools, obtain an identification code (marker) that provides predetermined reference coordinates, and generate a virtual image according to spatial information based on the obtained identification code.

However, when creating a virtual image based on an identification code, conventional methods are required to estimate the shape or area of the object to be registered to the virtual image based on the operator's subjective guess or idea.

As a result, conventional methods reveal difficulty in establishing a natural registration relationship between the virtual image and the object.

Meanwhile, conventional approaches introduce the inconvenience of separately installing a specialized software program to implement augmented reality based on the identification code.

In other words, although there may be a demand for the augmented reality environment, the desired AR environment may not be set up unless the current situation facilitates an easy installation of the separate software program.

On the other hand, recently, the evolution of information and communication technology has given rise to diverse technologies for data storage codes (e.g., QR code and/or barcode).

In particular, Quick Response (QR) code has an advantage of providing ample storage capacity and seamless integration with the Internet and multimedia, thereby being used widely in various industrial media.

The QR code is a code system capable of handling long Internet addresses, photos, and/or video information, thereby delivering very high usability and scalability.

### PRIOR ART REFERENCES

### Patents

(Patent 1) KR 10-2021-0073900 A

### SUMMARY

An object of the present disclosure is to implement a method and a system for providing a predetermined Augmented Reality (AR) object through the web environment based on a predetermined identification code.

Also, an object of the present disclosure is to implement a method and a system for providing a working environment in which a user may author an AR object registered more accurately to a predetermined actual object.

Technical objects to be achieved by the present disclosure and embodiments according to the present disclosure are not limited to the technical objects described above, and other technical objects may also be addressed.

A method for providing an AR object based on an identification code by a tracking application executed by at least one processor of a terminal according to the present disclosure comprises generating an AR library, which is a data set providing a predetermined augmented reality environment, based on at least one or more target objects; storing the AR library by matching the AR library to a first target object and a second target object; and providing an augmented reality environment based on the second target object and the AR library matched to the first target object when being connected to the web environment based on the first target object, wherein providing an augmented reality environment comprises obtaining a first image capturing the first target object through an image sensor of the terminal, detecting the first target object based on the obtained first image, obtaining an augmented reality web environment access link for providing the AR library matched to the detected first target object, obtaining a second image capturing the second target object through an image sensor of the terminal in the augmented reality environment accessed through the obtained link, detecting a second target object based on the obtained second image, and controlling a first virtual object included in the AR library to be augmented and displayed on the detected second target object.

At this time, the storing of the AR library by matching to the first target object may include generating a link providing a Uniform Resource Locator (URL) linked to the augmented reality environment and storing the link by matching the link to the first target object.

Also, the obtaining of the augmented reality web environment access link for providing the AR library may include capturing a first identification code image representing the first target object and recognizing the link matched to the first target object.

Also, the capturing of the first identification code image includes capturing the first identification code image implemented as at least one of a graphic identification code that represents the first target object in the form of a graphic image and a real identification code that prints the actual shape of the first target object.

Also, the obtaining of the second image capturing the second target object includes capturing the second target object which is an object that the first target object is attached or an object that exists separately from the first target object.

Also, the obtaining of the first image and the second image includes capturing the first target object and the second target object which are implemented as at least one of a 2D identification code, a 2D image and a 3D object.

Also, the providing of the augmented reality web environment may include determining 6 degrees of freedom and scale parameters of the at least one or more target objects and the first virtual object according to the change of a viewpoint from which the first image and the second image are captured.

Also, the storing the AR library by matching the AR library to the first target object may include generating a link providing a Uniform Resource Locator (URL) linked to the augmented reality environment and setting a short-range wireless communication medium for transmitting the link through short-range wireless communication.

Also, the obtaining of the augmented reality web environment access link for providing the AR library may include receiving the link from the set short-range wireless communication medium through short-range wireless communication.

Also, the setting of the short-range wireless communication medium may include recognizing the short-range wireless communication medium and recording to distribute the link over the recognized short-range wireless communication medium or displaying short-range wireless communication devices installed at a plurality of places on a map and setting up to distribute the link on at least one of the displayed short-range wireless communication devices.

Also, the generating of the AR library may include generating an AR project providing an AR library authoring interface and generating the AR library based on the AR library authoring interface of the generated AR project.

Also, the generating of the AR library based on the AR library authoring interface may include generating anchoring information determining 6 degrees of freedom and scale parameters of the first virtual object according to the change of the 6 degrees of freedom and scale parameters of the at least one or more target objects.

Also, the generating of the AR library based on the AR library authoring interface may include generating interaction information determining a predetermined event functional operation generated according to user input based on at least one or more target objects or the first virtual object.

Meanwhile, a system for providing an AR object based on an identification code comprises at least one memory storing a tracking application; and at least one processor implementing a method for providing an AR object based on an identification code by reading the tracking application stored in the memory, wherein commands of the tracking application include commands for performing: generating an AR library, which is a data set providing a predetermined augmented reality environment, based on at least one or more target objects, storing the AR library by matching the AR library to a first target and a second target object, and providing an augmented reality environment based on the second target and the AR library matched to the first target object when being connected to the web environment based on the first target object, wherein providing an augmented reality environment comprises obtaining a first image capturing the first target object through an image sensor of the terminal, detecting the first target object based on the obtained first image, obtaining an augmented reality web environment access link for providing the AR library matched to the detected first target object, obtaining a second image capturing the second target object through an image sensor of the terminal in the augmented reality environment accessed through the obtained link, detecting a second target object based on the obtained second image, and controlling a first virtual object included in the AR library to be augmented and displayed on the detected second target object.

A method and a system for providing an AR object based on an identification code according to an embodiment of the present disclosure provide a predetermined Augmented Reality (AR) object through the web environment based on a predetermined identification code; therefore, the method and the system provide an advantageous effect of providing an augmented reality environment in an easy and convenient manner across the web without being limited by environmental factors to implement the augmented reality environment (e.g., installation of a separate software program) once the predetermined identification code is recognized.

Also, the method and the system for providing an AR object based on an identification code according to an embodiment of the present disclosure provide a working environment in which a user may author an AR object registered with greater accuracy to a predetermined actual object, thereby providing an advantageous effect of delivering a more seamless augmented display by harmonizing the authored AR object with the predetermined actual object based on a predetermined identification code.

However, it should be noted that the technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 illustrates a system for providing an AR object based on an identification code according to an embodiment of the present disclosure.

FIG. 2 is an internal block diagram of a terminal according to an embodiment of the present disclosure.

FIG. 3 is a flow diagram illustrating a method for providing an AR object based on an identification code according to an embodiment of the present disclosure.

FIG. 4 is an exemplary drawing illustrating an AR project according to an embodiment of the present disclosure.

FIG. 5 is a flow diagram illustrating a method for generating an AR library according to an embodiment of the present disclosure.

FIG. 6 is an exemplary drawing illustrating a target criterion object according to an embodiment of the present disclosure.

FIG. 7 is an exemplary drawing illustrating a target virtual object according to an embodiment of the present disclosure.

FIG. 8 is an exemplary drawing illustrating a guide object according to an embodiment of the present disclosure.

FIG. 9 is an exemplary drawing illustrating an augmented reality web environment access link according to an embodiment of the present disclosure.

FIG. 10 is an exemplary drawing illustrating an augmented reality web environment based on an AR library according to an embodiment of the present disclosure.

FIG. 11 is a flow diagram illustrating a method for providing an AR object tracking service according to an embodiment of the present disclosure.

FIG. 12 is an exemplary drawing illustrating 6 degrees of freedom (DoF) parameters according to an embodiment of the present disclosure.

FIG. 13 is a flow diagram illustrating a method for determining a target criterion object from an object according to an embodiment of the present disclosure.

FIG. 14 is a flow diagram illustrating a method for calculating 3D depth data from signal image data according to an embodiment of the present disclosure.

FIG. 15(a), FIG. 15(b), FIG. 15(c) are an exemplary drawing illustrating a primitive model according to an embodiment of the present disclosure.

FIG. 16(a), FIG. 16(b), FIG. 16(c) are an exemplary drawing illustrating a method for aligning a primitive application model and a target object according to an embodiment of the present disclosure.

FIG. 17 is an exemplary drawing illustrating a method for setting attribute values of a primitive application model according to an embodiment of the present disclosure.

FIG. 18(a), FIG. 18(b), FIG. 18(c) are an exemplary drawing illustrating a method for calculating 3D depth data based on the attribute values of a primitive application model according to an embodiment of the present disclosure.

FIG. 19 is a conceptual drawing illustrating another method for calculating 3D depth data from single image data according to an embodiment of the present disclosure.

FIG. 20 is a conceptual drawing illustrating a method for generating 3D integrated depth data according to an embodiment of the present disclosure.

FIG. 21 is an exemplary drawing illustrating a 3D definition model according to an embodiment of the present disclosure.

FIG. 22 is an exemplary drawing illustrating an AR environment model according to an embodiment of the present disclosure.

FIG. 23 is an exemplary drawing illustrating AR object tracking according to an embodiment of the present disclosure.

FIG. 24 is a flow diagram illustrating an object tracking method for augmented reality according to an embodiment of the present disclosure.

FIG. 25 is an exemplary drawing illustrating a method for obtaining a 3D definition model based on a first viewpoint according to an embodiment of the present disclosure.

FIG. 26 is an exemplary drawing illustrating a guide virtual object according to an embodiment of the present disclosure.

FIG. 27 is an exemplary drawing illustrating a plurality of frame images according to an embodiment of the present disclosure.

FIG. 28 is an exemplary drawing illustrating descriptors within a plurality of frame images according to an embodiment of the present disclosure.

FIG. 29 is an exemplary drawing illustrating a key frame image according to an embodiment of the present disclosure.

### DETAILED DESCRIPTION

Since the present disclosure may be modified in various ways and may provide various embodiments, specific embodiments will be depicted in the appended drawings and described in detail with reference to the drawings. The effects and characteristics of the present disclosure and a method for achieving them will be clearly understood by referring to the embodiments described later in detail together with the appended drawings. However, it should be noted that the present disclosure is not limited to the embodiment disclosed below but may be implemented in various forms. In the following embodiments, the terms such as “first” and “second” are introduced to distinguish one element from the others, and thus the technical scope of the present disclosure should not be limited by those terms. Also, a singular expression should be understood to indicate a plural expression unless otherwise explicitly stated. The term “include” or “have” is used to indicate existence of an embodied feature or constituting element in the present specification; and should not be understood to preclude the possibility of adding one or more other features or constituting elements. Also, constituting elements in the figure may be exaggerated or shrunk for the convenience of descriptions. For example, since the size and thickness of each element in the figure have been arbitrarily modified for the convenience of descriptions, it should be noted that the present disclosure is not necessarily limited to what has been shown in the figure.

In what follows, embodiments of the present disclosure will be described in detail with reference to appended drawings. Throughout the specification, the same or corresponding constituting element is assigned the same reference number, and repeated descriptions thereof will be omitted.

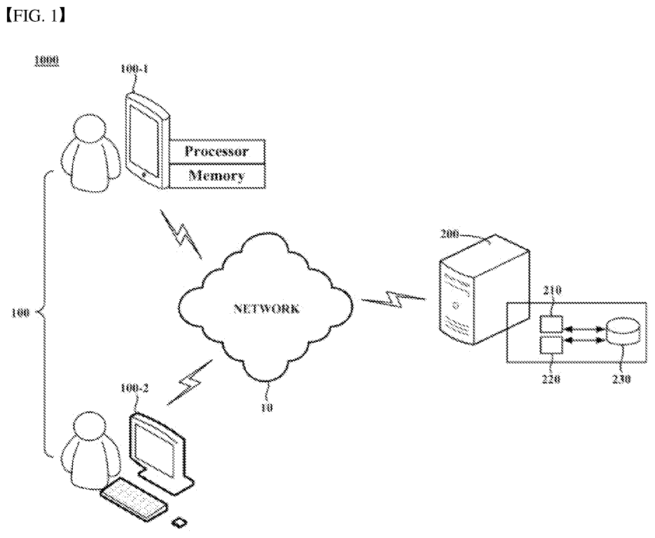

FIG. 1 illustrates a system for providing an AR object based on an identification code according to an embodiment of the present disclosure.

Referring to FIG. 1, a system for providing an AR object based on an identification code 1000 (AR object providing system) according to an embodiment of the present disclosure may implement an identification code-based AR object providing service (in what follows, AR object providing service) which provides a predetermined augmented reality (AR) object through the web environment based on an identification code attached to an actual object.

In the embodiment, the AR object providing system 1000 that implements the AR object providing service may include a terminal 100, an AR object providing server 200, and a network 300.

At this time, the terminal 100 and the AR object providing server 200 may be connected to each other through the network 300.

Here, the network 300 according to the embodiment refers to a connection structure that allows information exchange between individual nodes, such as the terminal 100 and/or the AR object providing server 200.

Examples of the network 300 include the 3rd Generation Partnership Project (3GPP) network, Long Term Evolution (LTE) network, World Interoperability for Microwave Access (WIMAX) network, Internet, Local Area Network (LAN), Wireless Local Area Network (WLAN), Wide Area Network (WAN), Personal Area Network (PAN), Bluetooth network, satellite broadcasting network, analog broadcasting network, and/or Digital Multimedia Broadcasting (DMB) network. However, the network according to the present disclosure is not limited to the examples above.

Hereinafter, the terminal 100 and the AR object providing server 200 that implement the AR object providing system 1000 will be described in detail with reference to the appended drawings.

### Terminal 100

The terminal 100 according to an embodiment of the present disclosure may be a predetermined computing device equipped with a tracking application (in what follows, an application) providing an AR object providing service.

Specifically, from a hardware point of view, the terminal 100 may include a mobile type computing device 100-1 and/or a desktop type computing device 100-2 equipped with an application.

Here, the mobile type computing device 100-1 may be a mobile device equipped with an application.

For example, the mobile type computing device 100-1 may include a smartphone, a mobile phone, a digital broadcasting device, a personal digital assistant (PDA), a portable multimedia player (PMP), and/or a tablet PC.

Also, the desktop type computing device 100-2 may be a wired/wireless communication-based device equipped with an application.

For example, the desktop type computing device 100-2 may include a stationary desktop PC, a laptop computer, and/or a personal computer such as an ultrabook.

Depending on the embodiment, the terminal 100 may further include a predetermined server computing device that provides an AR object providing service environment.

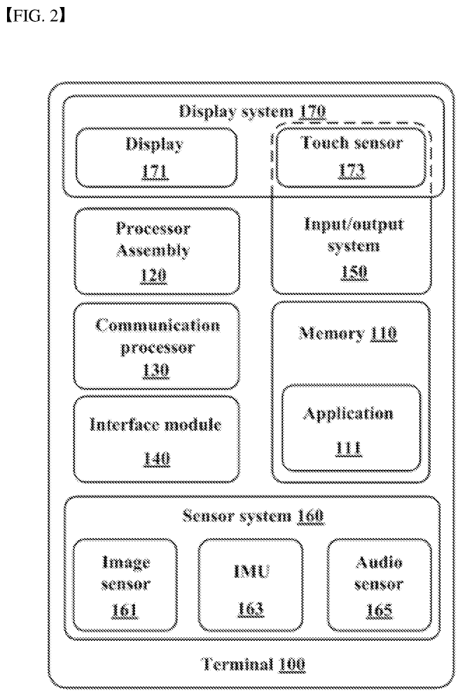

FIG. 2 is an internal block diagram of a terminal according to an embodiment of the present disclosure.

Meanwhile, referring to FIG. 2, from a functional point of view, the terminal 100 may include a memory 110, a processor assembly 120, a communication processor 130, an interface unit 140, an input system 150, a sensor system 160, and a display system 170. In the embodiment, the terminal 100 may include the above constituting elements within a housing.

Specifically, the memory 110 may store an application 111.

At this time, the application 111 may store one or more of various applications, data, and commands for providing an AR object providing service environment.

In other words, the memory 110 may store commands and data used to create an AR object providing service environment.

Also, the memory 110 may include a program area and a data area.

Here, the program area according to the embodiment may be linked between an operating system (OS) that boots the terminal 100 and functional elements.

Also, the data area according to the embodiment may store data generated according to the use of the terminal 100.

Also, the memory 110 may include at least one or more non-transitory computer-readable storage media and transitory computer-readable storage media.

For example, the memory 110 may be implemented using various storage devices such as a ROM, an EPROM, a flash drive, and a hard drive and may include a web storage that performs the storage function of the memory 110 on the Internet.

The processor assembly 120 may include at least one or more processors capable of executing instructions of the application 111 stored in the memory 110 to perform various tasks for creating an AR object providing service environment.

In the embodiment, the processor assembly 120 may control the overall operation of the constituting elements through the application 111 of the memory 110 to provide an AR object providing service.

Specifically, the processor assembly 120 may be a system-on-chip (SOC) suitable for the terminal 100 that includes a central processing unit (CPU) and/or a graphics processing unit (GPU).

Also, the processor assembly 120 may execute the operating system (OS) and/or application programs stored in the memory 110.

Also, the processor assembly 120 may control each constituting element mounted on the terminal 100.

Also, the processor assembly 120 may communicate internally with each constituting element via a system bus and may include one or more predetermined bus structures, including a local bus.

Also, the processor assembly 120 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or electrical units for performing other functions.

The communication processor 130 may include one or more devices for communicating with external devices. The communication processor 130 may communicate with external devices through a wireless network.

Specifically, the communication processor 130 may communicate with the terminal 100 that stores a content source for implementing an AR object providing service environment.

Also, the communication processor 130 may communicate with various user input components, such as a controller that receives user input.

In the embodiment, the communication processor 130 may transmit and receive various data related to the AR object providing service to and from another terminal 100 and/or an external server.

The communication processor 130 may transmit and receive data wirelessly to and from a base station, an external terminal 100, and an arbitrary server on a mobile communication network constructed through communication devices capable of performing technical standards or communication methods for mobile communication (e.g., Long Term Evolution (LTE), Long Term Evolution-Advanced (LTE-A), 5G New Radio (NR), WIFI) or short-distance communication.

Also, the communication processor 130 may further include at least one short-range communication module among a Near Field Communication (NFC) chip, a Bluetooth chip, an RFID reader, and a Zigbee chip for short-range communication.

The communication processor 130 may receive data including a link for receiving an AR library, which is a data set that provides an AR environment, through the short-range communication module.

The sensor system 160 may include various sensors such as an image sensor 161, a position sensor (IMU) 163, an audio sensor 165, a distance sensor, a proximity sensor, and a touch sensor.

Here, the image sensor 161 may capture images (images and/or videos) of the physical space around the terminal 100.

Specifically, the image sensor 161 may capture a predetermined physical space through a camera disposed toward the outside of the terminal 100.

In the embodiment, the image sensor 161 may be placed on the front or/and back of the terminal 100 and capture the physical space in the direction along which the image sensor 161 is disposed.

In the embodiment, the image sensor 161 may capture and acquire various images (e.g., shooted videos of identification code) related to the AR object providing service.

The image sensor 161 may include an image sensor device and an image processing module.

Specifically, the image sensor 161 may process still images or moving images obtained by an image sensor device (e.g., CMOS or CCD).

Also, the image sensor 161 may use an image processing module to process still images or moving images obtained through the image sensor device, extract necessary information, and transmit the extracted information to the processor.

The image sensor 161 may be a camera assembly including at least one or more cameras.

Here, the camera assembly may include a general-purpose camera that captures images in the visible light band and may further include a special camera such as an infrared camera or a stereo camera.

Also, depending on the embodiments, the image sensor 161 as described above may operate by being included in the terminal 100 or may be included in an external device (e.g., an external server) to operate in conjunction with the communication processor 130 and the interface unit 140.

The position sensor (IMU) 163 may detect at least one or more of the movement and acceleration of the terminal 100. For example, the position sensor 163 may be built from a combination of various position sensors such as accelerometers, gyroscopes, and/or magnetometers.

Also, the position sensor (IMU) 163 may recognize spatial information on the physical space around the terminal 100 in conjunction with the position communication processor 130, such as a GPS module of the communication processor 130.

The audio sensor 165 may recognize sounds around the terminal 100.

Specifically, the audio sensor 165 may include a microphone capable of detecting a voice input from a user using the terminal 100.

In the embodiment, the audio sensor 165 may receive voice data required for the AR object providing service from the user.

The interface unit 140 may connect the terminal 100 to one or more other devices to allow communication between them.

Specifically, the interface unit 140 may include a wired and/or wireless communication device compatible with one or more different communication protocols.

Through this interface unit 140, the terminal 100 may be connected to various input and output devices.

For example, the interface unit 140 may be connected to an audio output device such as a headset port or a speaker to output audio signals.

In the example, it is assumed that the audio output device is connected through the interface unit 140; however, embodiments in which the audio output device is installed inside the terminal 100 are equally supported.

Also, for example, the interface unit 140 may be connected to an input device such as a keyboard and/or a mouse to obtain user input.

The interface unit 140 may be implemented using at least one of a wired/wireless headset port, an external charger port, a wired/wireless data port, a memory card port, a port for connecting a device equipped with an identification module, an audio Input/Output (I/O) port, a video I/O port, an earphone port, a power amplifier, an RF circuit, a transceiver, and other communication circuits.

The input system 150 may detect user input (e.g., a gesture, a voice command, a button operation, or other types of input) related to the AR object providing service.

Specifically, the input system 150 may include a predetermined button, a touch sensor, and/or an image sensor 161 that receives a user motion input.

Also, by being connected to an external controller through the interface unit 140, the input system 150 may receive user input.

The display system 170 may output various information related to the AR object providing service as a graphic image.

In the embodiment, the display system 170 may display various user interfaces for the AR object providing service, shooted videos of identification code, guide objects, augmented reality web environment access links, an augmented reality (web) environment, object shooting guides, additional object shooting guides, shooted videos, primitive models, 3D definition models, AR environment models, and/or virtual objects.

The display system 170 may be built using at least one of, but is not limited to, a liquid crystal display (LCD), thin film transistor-liquid crystal display (TFT LCD), organic light-emitting diode (OLED), flexible display, 3D display, and/or e-ink display.

Additionally, depending on the embodiment, the display system 170 may include a display 171 that outputs an image and a touch sensor 173 that detects a user's touch input.

For example, the display 171 may implement a touch screen by forming a mutual layer structure or being integrated with a touch sensor 173.

The touch screen may provide an input interface between the terminal 100 and the user and, at the same time, an output interface between the terminal 100 and the user.

Meanwhile, the terminal 100 according to an embodiment of the present disclosure may perform deep learning related to an object tracking service in conjunction with a predetermined deep learning neural network.

Here, the deep learning neural network according to the embodiment may include, but is not limited to, the Convolution Neural Network (CNN), Deep Plane Sweep Network (DPSNet), Attention Guided Network (AGN), Regions with CNN features (R-CNN), Fast R-CNN, Faster R-CNN, Mask R-CNN, and/or U-Net network.

Specifically, in the embodiment, the terminal 100 may perform monocular depth estimation (MDE) in conjunction with a predetermined deep learning neural network (e.g., CNN).

For reference, monocular depth estimation (MDE) is a deep learning technique that uses single image data as input and outputs 3D depth data for the single input image data.

Also, in the embodiment, the terminal 100 may perform semantic segmentation (SS) in conjunction with a predetermined deep learning neural network (e.g., CNN).

For reference, semantic segmentation (SS) may refer to a deep learning technique that segments and recognizes each object included in a predetermined image in physically meaningful units.

At this time, depending on the embodiments, the terminal 100 may perform monocular depth estimation (MDE) and semantic segmentation (SS) in parallel. Meanwhile, depending on the embodiments, the terminal 100 may further perform at least part of the functional operations performed by the AR object providing server 200, which will be described later.

### AR Object Providing Server 200

Meanwhile, the AR object providing server 200 according to an embodiment of the present disclosure may perform a series of processes for providing an AR object providing service.

Specifically, the AR object providing server 200 according to the embodiment may provide an AR object providing service by exchanging data required to operate an identification code-based AR object providing process in an external device, such as the terminal 100, with the external device.

More specifically, the AR object providing server 200 according to the embodiment may provide an environment in which an application 111 operates in an external device (in the embodiment, the mobile type computing device 100-1 and/or desktop type computing device 100-2).

For this purpose, the AR object providing server 200 may include an application program, data, and/or commands for operating the application 111 and may transmit and receive various data based thereon to and from the external device.

Also, in the embodiment, the AR object providing server 200 may create an AR project.

Here, the AR project according to the embodiment may mean an environment that produces a data set (in the embodiment, an AR library) for providing a predetermined augmented reality environment based on a target object.

Also, in the embodiment, the AR object providing server 200 may generate at least one AR library based on the created AR project.

At this time, in the embodiment, the AR library may include a target object including a target identification code, a target virtual object, anchoring information, augmented reality environment setting information, an augmented reality web environment access link matched to the target identification code and/or an augmented reality web environment that matches the target identification code.

Also, in the embodiment, the AR object providing server 200 may build an AR library database based on at least one AR library generated.

Also, in the embodiment, the AR object providing server 200 may recognize a predetermined target identification code.

Here, the target identification code according to the embodiment may mean a target object that provides an augmented reality environment access link connected to a predetermined augmented reality environment.

Also, in the embodiment, the AR object providing server 200 may provide a predetermined augmented reality web environment access link based on the recognized target identification code.

Here, the augmented reality web environment access link according to the embodiment may mean a Uniform Resource Locator (URL) directing to a predetermined augmented reality environment (in the embodiment, augmented reality web environment) implemented based on the web environment and/or an image including a URL (hereinafter, a URL image).

Also, in the embodiment, the AR object providing server 200 may provide a predetermined augmented reality web environment based on the provided augmented reality web environment access link.

Also, in the embodiment, the AR object providing server 200 may recognize a predetermined target object in the provided augmented reality web environment.

Here, the target object according to the embodiment may mean an object that provides a criterion for tracking a virtual object in a predetermined augmented reality environment and/or an object that provides a criterion for tracking changes in the 6 DoF and scale parameters of a virtual object displayed on a predetermined augmented reality environment.

Also, in the embodiment, the AR object providing server 200 may determine a target criterion object.

Here, the target criterion object according to the embodiment may mean a 3D definition model for a target object for which tracking is to be performed.

Also, in the embodiment, the AR object providing server 200 may determine the target virtual object.

Here, the target virtual object according to the embodiment may mean a 3D virtual object for augmented display in conjunction with the target criterion object.

Also, in the embodiment, the AR object providing server 200 may provide an AR object providing service that augments the target virtual object on a recognized target object.

Also, in the embodiment, the AR object providing server 200 may perform deep learning required for an object tracking service in conjunction with a predetermined deep-learning neural network.

In the embodiment, the AR object providing server 200 may perform monocular depth estimation (MDE) and semantic segmentation (SS) in parallel in conjunction with a predetermined deep learning neural network (e.g., CNN).

Specifically, in the embodiment, the AR object providing server 200 may read a predetermined deep neural network driving program built to perform the deep learning from the memory module 230.

Also, the AR object providing server 200 may perform deep learning required for the following object tracking service according to the predetermined deep neural network driving program.

Here, the deep learning neural network according to the embodiment may include, but is not limited to, the Convolution Neural Network (CNN), Deep Plane Sweep Network (DPSNet), Attention Guided Network (AGN), Regions with CNN features (R-CNN), Fast R-CNN, Faster R-CNN, Mask R-CNN, and/or U-Net network.

At this time, depending on the embodiments, the deep learning neural network may be directly included in the AR object providing server 200 or may be implemented as a separate device and/or a server from the AR object providing server 200.

In the following description, it is assumed that the deep learning neural network is described as being included in the AR object providing server 200, but the present disclosure is not limited to the specific assumption.

Also, in the embodiment, the AR object providing server 200 may store and manage various application programs, commands, and/or data for implementing the AR object providing service.

In the embodiment, the AR object providing server 200 may store and manage at least one or more AR projects, an AR library, a target object including a target identification code and a target criterion object, a target virtual object, a primitive model, a primitive application model, primitive model attribute values, a guide object, an augmented reality web environment access link, an augmented reality web environment, user account information, group member information, an AR environment library, an AR environment model, a 3D definition model, an object shooting guide, an additional object shooting guide, shooted videos, key frame images, learning data, 3D depth data, deep learning algorithms, and/or a user interface.

However, the functional operations that the AR object providing server 200 according to the embodiment of the present disclosure may perform are not limited to the above, and other functional operations may be further performed.

Meanwhile, referring further to FIG. 1, the AR object providing server 200 according to the embodiment may be implemented as a predetermined computing device that includes at least one or more processor modules 210 for data processing, at least one or more communication modules 220 for exchanging data with an external device, and at least one or more memory modules 230 storing various application programs, data, and/or commands for providing the AR object providing service.

Here, the memory module 230 may store one or more of the operating system (OS), various application programs, data, and commands for providing the AR object providing service.

Also, the memory module 230 may include a program area and a data area.

At this time, the program area according to the embodiment may be linked between an operating system (OS) that boots the server and functional elements.

Also, the data area according to the embodiment may store data generated according to the use of the server.

Also, the memory module 230 may be implemented using various storage devices such as a ROM, a RAM, an EPROM, a flash drive, and a hard drive and may be implemented using a web storage that performs the storage function of the memory module on the Internet.

Also, the memory module 230 may be a recording module removable from the server.

Meanwhile, the processor module 210 may control the overall operation of the individual units described above to implement the AR object providing service.

Specifically, the processor module 210 may be a system-on-chip (SOC) suitable for the server that includes a central processing unit (CPU) and/or a graphics processing unit (GPU).

Also, the processor module 210 may execute the operating system (OS) and/or application programs stored in the memory module 230.

Also, the processor module 210 may control individual constituting elements installed in the server.

Also, the processor module 210 may communicate internally with each constituting element via a system bus and may include one or more predetermined bus structures, including a local bus.

Also, the processor module 210 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or electrical units for performing other functions.

In the description above, it was assumed that the AR object providing server 200 according to an embodiment of the present disclosure performs the functional operations described above; however, depending on the embodiments, an external device (e.g., the terminal 100) may perform at least part of the functional operations performed by the AR object providing server 200, or the AR object providing server 200 may further perform at least part of the functional operations performed by the external device, where various embodiments may be implemented in a similar manner.

### Method for Providing an AR Object Based on an Identification Code

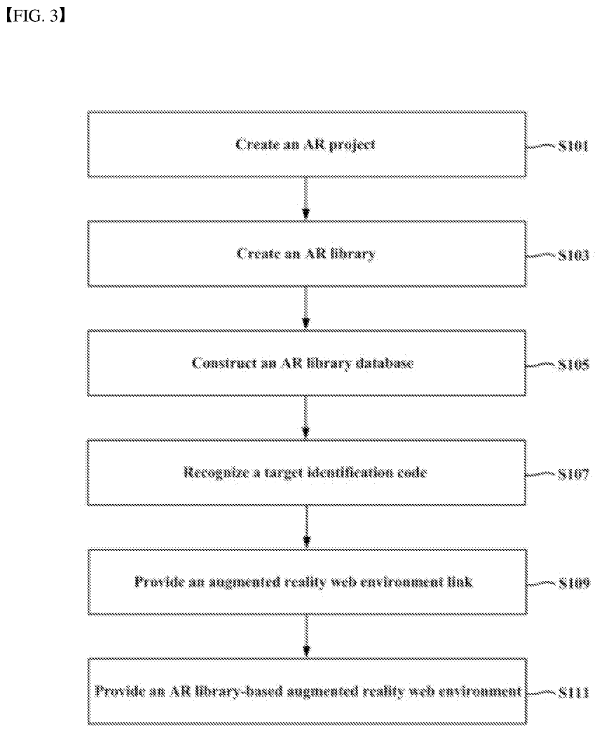

In what follows, a method for implementing an AR object providing service by an application 111 executed by at least one or more processors of the terminal 100 according to an embodiment of the present disclosure will be described in detail with reference to FIGS. 3 to 10.

At least one or more processors of the terminal 100 according to an embodiment of the present disclosure may execute at least one or more applications 111 stored in at least one or more memories 110 or make the applications operate in the background.

In what follows, the process in which at least one or more processors of the terminal 100 execute the commands of the application 111 to perform the method for implementing an AR object providing service will be described by assuming that the application 111 performs the process.

FIG. 3 is a flow diagram illustrating a method for providing an AR object based on an identification code according to an embodiment of the present disclosure.

Referring to FIG. 3, in the embodiment, the application 111 executed by at least one or more processors of the terminal 100 or operating in the background mode may create an AR project S101.

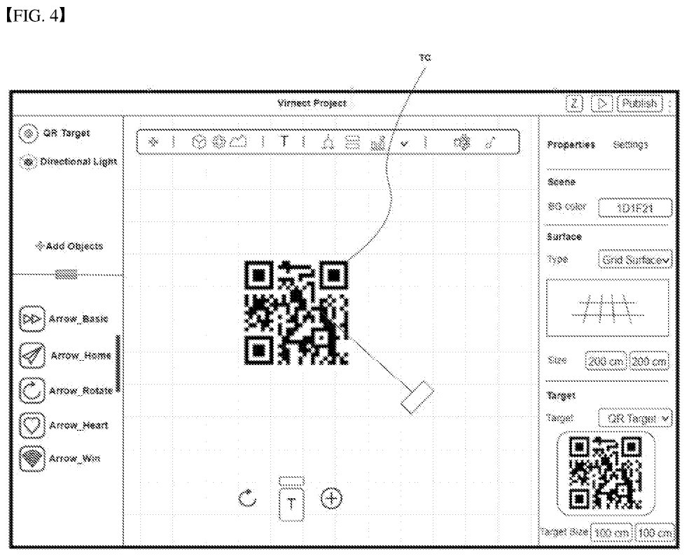

FIG. 4 is an exemplary drawing illustrating an AR project according to an embodiment of the present disclosure.

Here, referring to FIG. 4, the AR project according to an embodiment may mean a platform for creating a data set (in what follows, an AR library) necessary for providing an environment to augment predetermined AR content onto a real object identical to a preconfigured first target object (in what follows, an object) and/or a separately preconfigured second target object when the first target object is recognized.

At this time, the target object according to the embodiment may mean an object used as a criterion for tracking changes in the 6 DoF and scale parameters of an object providing an augmented reality environment access link directed to a predetermined augmented reality environment and/or a virtual object displayed on a predetermined augmented reality environment.

In the embodiment, the target object may be implemented using at least one of a 2D identification code, a 2D image, and/or a 3D object.

A first embodiment implementing the target object as a 2D identification code may performs a process in which a randomly generated identification code (e.g., a barcode and/or a QR code) is assigned and the assigned identification code is determined as the target object.

However, a second embodiment implementing the target object as a 3D object may perform a process in which, if an image including the shape of an object is captured and uploaded, the corresponding object is determined as the target object.

At this time, since the image including the shape of the object is an image taken from a particular viewpoint, the target object may not be recognized from another viewpoint.

Therefore, in the embodiment, the application 111 may provide an object tracking service for recognizing a 3D object as a target object. More details on the providing of the object tracking service will be described later.

In what follows, for the purpose of convenience, it is assumed that a target object providing an augmented reality environment access link directing to the predetermined augmented reality environment is implemented as a 2D identification code, and the target object may be referred to as a target identification code. Also, the object used as a criterion for the tracking, which is a virtual object representing a predetermined real object on the application, may be referred to as a target criterion object.

In other words, in the embodiment, the target object may include a target identification code and/or a target criterion object.

In the embodiment, the AR library may include a target identification code TC, an augmented reality (web and/or app) environment access link connected based on the target identification code TC, a target object matched to the target identification code TC, a virtual object anchored to the target object (in what follows, a target virtual object), anchoring information between the target object and the target virtual object, and/or augmented reality environment setting information.

In the embodiment, the target identification code TC may include a graphic identification code that represents the target identification code TC in the form of a graphic image and a real identification code that prints the actual shape of the target identification code TC.

Also, the anchoring information according to the embodiment may indicate registration data for relationships between object poses (positions and/or orientations) and scales which determine the changes in the 6 DoF and scale parameters of a predetermined virtual object to respond to the changes in the 6 DoF and scale parameters of the target object (in the embodiment, the target identification code TC and/or the target criterion object CO).

Also, the augmented reality environment setting information according to the embodiment may indicate the information setting a specific effect implemented based on the target object and/or target virtual object on a predetermined augmented reality environment. Detailed descriptions of the above will be provided in the following steps, denoted with the prefix “S.”

Specifically, in the embodiment, the application 111 may create an AR project on the AR object providing service platform according to a predetermined user input.

In other words, the application 111 may create and provide an environment for authoring an AR library according to a predetermined user input.

Also, in the embodiment, the application 111 may create the AR library S103.

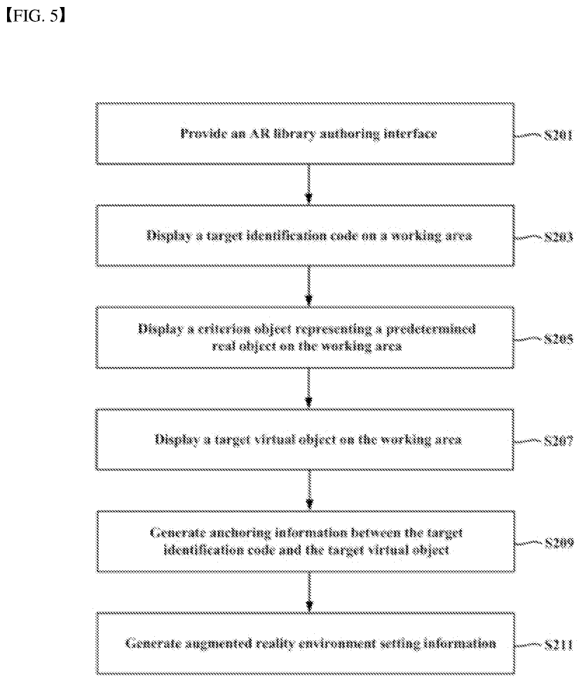

FIG. 5 is a flow diagram illustrating a method for generating an AR library according to an embodiment of the present disclosure.

Specifically, referring to FIG. 5, in the embodiment, the application 111 may provide a user interface (in what follows, AR library authoring interface) through which a user may produce an AR library based on a created AR project S201.

At this time, the AR library authoring interface according to the embodiment may include an identification code setting interface through which a user may set the attributes of a target identification code TC.

Also, the AR library authoring interface according to the embodiment may include a criterion object setting interface through which a user may set the attributes of a target criterion object, which is a virtual object representing a predetermined real object.

Also, the AR library authoring interface according to the embodiment may include a CAD interface through which a user may design a target criterion object to be matched to a target identification code TC (i.e., graphic identification code) displayed as a graphic image on the AR project and/or a virtual object to be augmented on the target criterion object.

Also, the AR library authoring interface according to the embodiment may include an interaction setting interface through which a user may set user interaction based on a graphic identification code displayed on a predetermined image and/or a predetermined virtual object.

To continue the description, in the embodiment, the application 111 may create an AR library based on user input based on the AR library authoring interface.

Specifically, in the embodiment, the application 111 may display the target identification code TC on the work area of the AR project based on the AR library authoring interface S203.

In other words, the application 111 may display a graphic identification code that displays the target identification code TC as a graphic image on the work area of the AR project.

In the embodiment, the application 111 may display a graphic identification code based on a preconfigured criterion point (e.g., center point) on the work area.

At this time, in the embodiment, the application 111 may set attribute information (in what follows, identification code attribute information) of the target identification code TC using the user input based on the AR library authoring interface.

Here, the identification code attribute information according to the embodiment may include the type (e.g., QR code or bar) and/or size information of the target identification code TC.

Therefore, the application 111 may establish a connection to an environment that provides AR object provision services by using any type of identification code if the code is a printable 2D identification code.

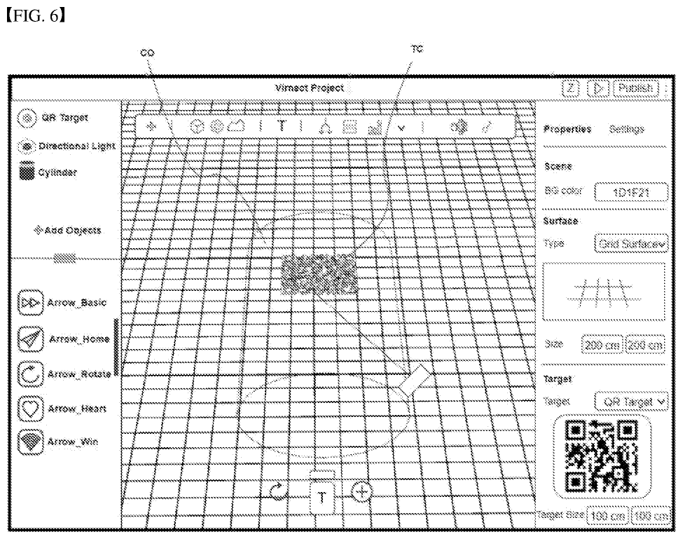

FIG. 6 is an exemplary drawing illustrating a target criterion object according to an embodiment of the present disclosure.

Also, referring to FIG. 6, in the embodiment, the application 111 may set a target criterion object CO, which is a virtual object representing a predetermined real object, on the work area of the AR project S205.

Here, the target criterion object CO according to the embodiment may be an object to which a target identification code TC is attached or an object that exists separately from the target identification code TC. For the convenience of description, FIG. 6 assumes that the object to which the target identification code TC is attached is the target criterion object CO.

Specifically, when a virtual object is designed based on a specific identification code, it may be necessary to consider the occupied area of the real object to be associated with the designed virtual object.

For example, suppose a user attaches a first identification code to a first real object (e.g., a mug) and scans a first identification code attached, and the application 111 attempts to augment and display a first virtual object (e.g., a kettle virtual object pouring water into the mug) on a first target criterion object having the same shape of the first real object; if there exists a relationship between the areas of the first virtual object and the first real object, it may be necessary to consider the digital area of the first real object when the first virtual object is designed.

Therefore, in the embodiment of the present disclosure, when designing a predetermined virtual object to be augmented to a real object based on a graphic identification code, the application 111 may display a target criterion object CO representing an area of the predetermined real object linked to the virtual object to be designed on the work area.

At this time, the target criterion object CO according to the embodiment may be stored in the AR project and in the AR library created through the AR project.

In other words, the target criterion object CO may be set and displayed on the AR project to assist the virtual object authoring function and may be displayed translucently as a guide object in the augmented reality environment to be provided based on the AR library so that the user may easily scan the target criterion object CO.

More specifically, in the embodiment, the application 111 may set attribute information (in what follows, criterion object attribute information) of the target criterion object CO based on user input from the AR library authoring interface.

Here, the criterion object attribute information according to the embodiment may include the shape and size of the target criterion object CO and/or target identification code TC position information for the target criterion object CO.

In the embodiment, the application 111 may determine shape and/or size information of the target criterion object CO based on a preconfigured primitive model (e.g., sphere, cylinder, hexahedron, and/or cone).

Also, in the embodiment, the application 111 may determine the shape and size information of the target criterion object CO based on a pre-built 3D model for each predetermined object type (e.g., a mug, a beverage can, and/or a water bottle).

Also, the application 111 may display a virtual object according to the determined shape and/or size of a target criterion object CO on the work area as a target criterion object CO.

At this time, in the embodiment, the application 111 may determine the position information of the target identification code TC for the target criterion object CO based on the target criterion object CO displayed on the work area and/or from the user input based on a graphic identification code.

Accordingly, the application 111 may enable the user to specify in advance the position for attaching the target identification code TC on the real object represented by the target criterion object CO and perform authoring of a virtual object based on the target criterion object CO by reflecting the specified position.

Therefore, the application 111 may support the display of the authored virtual object more seamlessly with the real object.

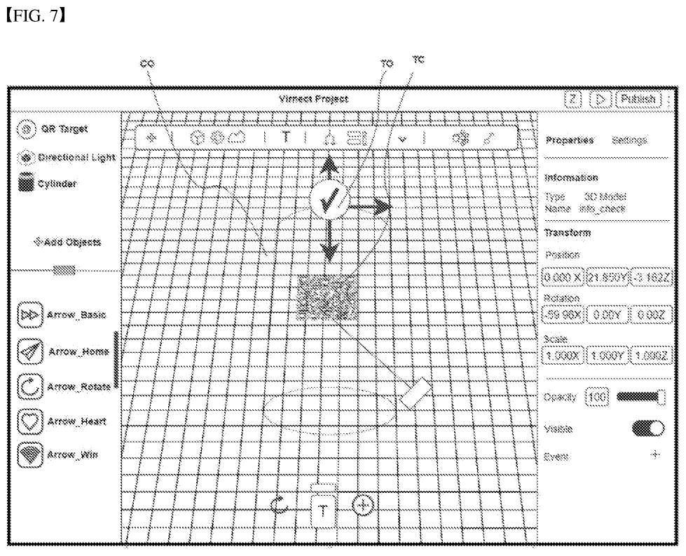

FIG. 7 is an exemplary drawing illustrating a target virtual object according to an embodiment of the present disclosure.

Also, referring to FIG. 7, the application according to the embodiment may display a target virtual object TO on the work area of the AR project S207.

Specifically, the application 111 according to the embodiment may determine the target virtual object TO.

In other words, the target virtual object TO according to the embodiment may be a virtual object anchored to a target criterion object CO, which may be a virtual object to be augmented and displayed on the target criterion object CO based on the target identification code TC.

More specifically, in the embodiment, the application 111 may determine the target virtual object TO based on at least one virtual object template provided by the AR object providing service platform.

Specifically, the application 111 may determine the target virtual object TO based on the user input which selects at least one from at least one virtual object template.

Also, in the embodiment, the application 111 may determine the target virtual object TO based on a 3D CAD model provided outside of the AR object providing service platform.

Specifically, the application 111 may receive a 3D CAD model compatible with the AR object providing service platform from a predetermined external server.

Then, the application 111 may determine the target virtual object TO from the user input based on the received 3D CAD model.

Also, in the embodiment, the application 111 may provide a virtual object authoring tool based on the AR library authoring interface.

Then the application 111 may create a virtual object according to user input based on the virtual object authoring tool.

Also, the application 111 may determine the target virtual object TO based on the created virtual object.

Also, in the embodiment, the application 111 may generate anchoring information between the target criterion object CO and the target virtual object TO S209.

In other words, anchoring information according to the embodiment may indicate registration data for relationships between object poses (positions and/or orientations) and scales which determine the changes in the 6 DoF and scale parameters of a predetermined virtual object to respond to the changes in the 6 DoF and scale parameters of the target criterion object CO.

In other words, in the embodiment, the application 111 may generate anchoring information that determines the changes in the 6 DoF and scale parameters of the target virtual object TO according to the changes in the 6 DoF and scale parameters of the target criterion object CO.

Also, in the embodiment, the application 111 may generate augmented reality setting information S211.

In other words, the augmented reality environment setting information according to the embodiment may mean information that sets a specific effect implemented based on the target virtual object TO in a predetermined augmented reality environment.

In the embodiment, the augmented reality environment setting information may include virtual lighting information and/or interaction information based on the target virtual object TO.

Specifically, in the embodiment, the application 111 may set virtual lighting information from the user input based on the AR library authoring interface.

Here, the virtual lighting information according to the embodiment may be the information that sets the brightness and/or shadow value for at least a portion of the areas of the target virtual object TO.

For example, the application 111 may obtain user input for setting the position and/or direction of virtual lighting on the work area based on the AR library authoring interface.

Then the application 111 may set the brightness and/or shadow value (i.e., virtual lighting information) for at least a portion of the areas of the target virtual object TO according to the position and/or direction of the virtual lighting set based on the received user input.

Also, in the embodiment, the application 111 may set interaction information from the user input based on the AR library production interface.

Here, the interaction information according to the embodiment may be the information that sets a specific event triggered as an interaction occurs between the target identification code TC and/or the target virtual object TO and the user.

Specifically, in the embodiment, the application 111 may set the interaction information used to perform a first event (e.g., access to a specific web page) if a first user input (e.g., a touch and/or drag input) to the target identification code TC and/or target virtual object TO is detected.

Through the setting above, the application 111 may not only augment and display a specific virtual object through the AR object providing service but also implement and provide various functional operations based on the augmented and displayed virtual object or target identification code TC.

To continue the description, the application 111 according to the embodiment may generate augmented reality setting information including set virtual lighting information and/or interaction information.

Returning to FIG. 4, the application 111 according to the embodiment may create an AR library that includes a target identification code TC, a target criterion object CO, a target virtual object TO, anchoring information, and/or augmented reality setting information.

Also, in the embodiment, the application 111 may build an AR library database S105.

Specifically, in the embodiment, the application 111 may store and manage the created AR library by matching the AR library to the target identification code TC included in the AR library. In other words, in the embodiment, the application 111 may store and manage different AR libraries by matching the AR libraries to the respective target identification codes TCs.

At this time, in the embodiment, the application 111 may store and manage the augmented reality web environment access link by matching the link to the target identification code TC.

Here, the augmented reality web environment access link according to the embodiment may mean a Uniform Resource Locator (URL) that accesses a predetermined augmented reality environment (in what follows, augmented reality web environment) implemented based on the web environment and/or an image including the URL (in what follows, URL image).

Specifically, in the embodiment, the application 111 may generate a first augmented reality web environment access link (i.e., URL and/or URL image) specialized for the first target identification code TC.

Also, the application 111 may connect the created first augmented reality web environment access link to the first augmented reality environment implemented based on the first AR library matched to the first target identification code TC.

In other words, the application 111 may generate a first augmented reality web environment access link that provides a URL and/or a URL image for accessing the first augmented reality environment.

Then the application 111 may store and manage the generated first augmented reality web environment access link by matching the link to the target identification code TC.

In other words, in the embodiment, the augmented reality web environment access link matched to the target identification code TC may be a URL and/or a URL image that may access the augmented reality web environment based on the AR library matched to the target identification code TC.

Therefore, in the embodiment, the application 111 may create an AR library, which is a data set that includes a target identification code TC, a target criterion object CO, a target virtual object TO, anchoring information, augmented reality environment setting information, an augmented reality web environment access link matched to the target identification code TC, and/or an augmented reality environment matched to the target identification code TC.

Then the application 111 may store and manage the created AR library by matching the library to the target identification code TC included in the AR library.

At this time, the application 111 may build an AR library database by creating at least one AR library and storing the created AR library by matching the AR library to the target identification code TC included in the AR library.

Through the operation above, when recognizing a specific target identification code TC later, the application 111 may access a web page that provides an augmented reality environment based on the AR library matched to the target identification code TC through the URL and/or URL image matched to the recognized target identification code TC.

Meanwhile, the application 111 may provide a process for setting up information on the augmented reality web environment access link to access the created AR library to be provided through short-range wireless communication.

Specifically, after creating the AR library, the application 111 may provide a process for distributing information such as a link for accessing an augmented reality web environment based on the generated AR library by matching the AR library to a short-range communication medium. In what follows, the process for distributing an AR library through a short-range communication medium will be described using the NFC communication as a representative example among short-range wireless communication technologies.

In the embodiment, the application 111 may recognize an NFC tag through an NFC module after activating an NFC function. At this time, the NFC tag is an NFC tag with empty data or a tag that may be reprogrammed with data.

The application 111 may then provide the user with an option to match an AR library to be distributed to the recognized NFC tag.

Next, the application 111 may determine to add an augmented reality web environment link based on the selected AR library as a record of the NFC tag.

To this end, the application 111 may store and manage the identification code of the recognized NFC tag and the AR library determined to be distributed by matching the AR library to the recognized NFC tag.

Then the application 111 may transmit data by controlling the NFC module to record the AR library matched to the NFC tag.

Afterward, the application 111 may match and store a plurality of AR libraries and identification codes of NFC tags set to distribute the AR libraries and provide an interface through which a user may perform editing of matching status between each AR library and NFC identification code and modifying/deleting individual AR libraries and NFC identification codes. Here, the identification code of the NFC tag may be a target identification code TC.

Also, the application 111 may provide a process for setting up a device capable of short-range communication registered in the server to distribute the AR library.

For example, the application 111 may provide an interface for setting a place or location where AR libraries registered in the AR object providing server 200 may be distributed.

In other words, the AR object providing server 200 may communicate with short-range wireless communication devices installed in a plurality of different locations that may distribute the AR library created by the user through short-range wireless communication and remotely perform setting of the AR library to be distributed by the corresponding short-range wireless communication device.

Therefore, the application 111 may determine one of the short-range wireless devices registered in the AR object providing server 200 based on location or place information and transmit the information on the determined device to the AR object providing server 200 so that the determined short-range wireless communication device may distribute the pre-designed AR library.

To this end, the application 111 may provide a plurality of locations on a map where AR libraries may be distributed based on the location information, and the user may select one of the locations and request the AR object providing server 200 to distribute the AR library from a short-range communication device at the selected location.

Upon receiving the user's request, the AR object providing server 200 may transmit an augmented reality web environment link based on a pre-stored AR library to a short-range wireless communication device and set the short-range wireless communication device to transmit the augmented reality web environment link. The AR object providing server 200 may charge for the distribution service provided.

Meanwhile, in the embodiment, the application 111 may perform storing and managing of various data required for at least part of the functional operations described above in conjunction with the AR object providing server 200.

As described above, the application 111 according to the embodiment of the present disclosure may provide a working environment in which a user may easily and effectively create a virtual object to be augmented and displayed on the target criterion object CO based on a predetermined 2D identification code.

Also, the application 111 according to the embodiment of the present disclosure may easily build a data set (in the embodiment, an AR library) with which a user may augment and display a predetermined virtual object on the target criterion object CO based on the predetermined, physically printable 2D identification code.

Through the operation above, the application 111 may provide an augmented reality environment for the target criterion object CO based on the 2D identification code anywhere, whether online or offline, provided the corresponding 2D identification code exists.

Also, in the embodiment, the application 111 may recognize the target identification code TC S107.

Specifically, in the embodiment, the application 111, in conjunction with the image sensor 161, may recognize an actual identification code obtained by printing the graphic identification code representing the target identification code TC in the form of a graphic image or target identification code TC.

More specifically, in the embodiment, the application 111 may obtain the video shooted using the image sensor 161 with the graphic identification code or an image of the physical identification code (in what follows, shooted video of identification code and/or a first image).

Then the application 111 may perform recognition of the target identification code TC using based on the image analysis of the graphic identification code within the obtained shooted video of identification code or the physical identification code.

At this time, the application 111 may execute an identification code recognition process using various well-known algorithms, and the embodiment of the present disclosure does not specify or limit the algorithm itself for executing the identification code recognition process.

For example, the application 111 may obtain the shooted video of identification code obtained by capturing the graphic identification code displayed on a display screen using the image sensor 161.

Then the application 111 may perform recognition of the target identification code TC based on the image analysis of the graphic identification code within the obtained shooted videos of identification code.

In another embodiment, the application 111 may obtain the shooted videos of identification code obtained by capturing the physical identification code printed according to a predetermined method and attached on a predetermined real object by using the image sensor 161.

Then the application 111 may perform recognition of the target identification code TC based on the image analysis of the physical identification code within the obtained shooted videos of identification code.

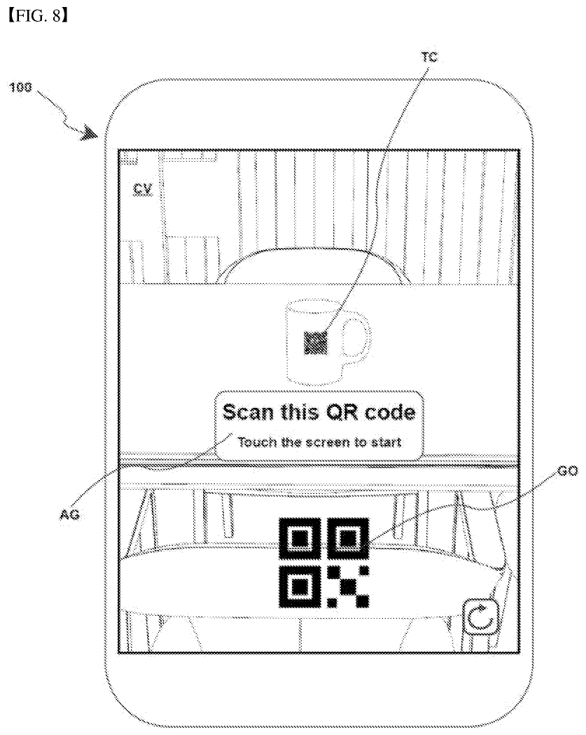

FIG. 8 is an exemplary drawing illustrating a guide object according to an embodiment of the present disclosure.

At this time, referring to FIG. 8, the application according to the embodiment may display a preconfigured guide object GO on the shooted videos of identification code CV.

Here, the guide object GO according to the embodiment may mean a virtual object that guides a scale and/or a position threshold required for a target object (in the embodiment, the target identification code TC and/or target criterion object CO) within the shooted videos of identification code CV.

At this time, the scale and/or position threshold (in what follows, recognition threshold) required for the target object may be scale and/or position criterion value that determines whether to perform the target object recognition process.

In other words, in the embodiment, the application 111 may perform target object recognition if the scale and/or position of a target object within the shooted videos of identification code CV satisfies a predetermined condition based on a recognition threshold (e.g., greater than or less than the recognition threshold).

On the other hand, the application 111 may not perform target object recognition if the scale and/or position of the target object within the shooted videos of identification code CV fails to meet the predetermined condition based on the recognition threshold.

FIG. 8 shows an image displaying a guide object GO for the target identification code TC of the target object, where the guide object GO may also be displayed for the target criterion object CO of the target object in the same method described later.

Specifically, in an embodiment, the application 111 may augment and display the guide object GO having a first shape (e.g., a predetermined identification code shape), which guides a first recognition threshold (i.e., a first scale threshold and/or a first position threshold), on the shooted videos of identification code CV.

Also, the application 111 may determine whether the scale and/or position of the target identification code TC within the shooted videos of identification code CV satisfies a predetermined condition based on the first recognition threshold.

Then, if the application 111 determines that the predetermined condition based on the first recognition threshold is met, the application 111 may perform recognition of the target identification code TC.

On the other hand, if the application 111 determines that the predetermined condition based on the first recognition threshold is not met, the application 111 may provide an additional guide AG guiding the target identification code (TC) to have a scale and/or a position that meets the predetermined condition based on the first recognition threshold.

For example, the application 111 may provide, as an additional guide (AG), predetermined audio, image, and/or haptic data that guides the target identification code TC to have a scale and/or a position that meets a predetermined condition based on the first recognition threshold.

In this way, the application 111 may perform recognition of the target identification code TC if the target identification code TC within the shooted videos of identification code CV meets the preset scale and/or position.

Therefore, the application 111 may prevent in advance factors from degrading the identification code recognition performance and the quality of the AR object providing service based on the identification code recognition, as observed in the situations such as when the size of the target identification code TC within the shooted videos of identification code CV is too small or when the target identification code TC within the shooted videos of identification code CV is positioned in an area that does not have a sufficient space to augment a virtual object anchored to the target criterion object CO of the corresponding target identification code TC.

Also, in the embodiment, the application 111 may provide an augmented reality web environment access link S109.

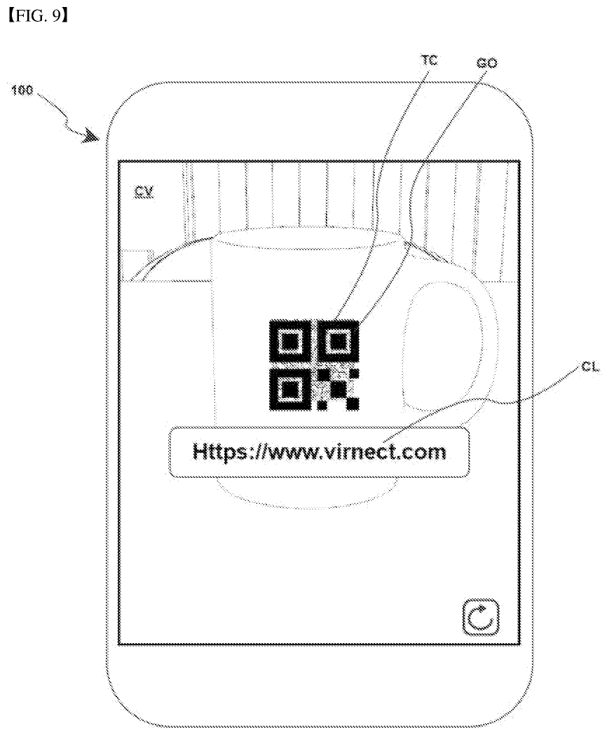

FIG. 9 is an exemplary drawing illustrating an augmented reality web environment access link according to an embodiment of the present disclosure.

Specifically, referring to FIG. 9, the application 111 according to the embodiment may provide, based on a recognized target identification code TC, a link CL (in the embodiment, the augmented reality web environment access link) through which an augmented reality web environment based on an AR library matched to the target identification code TC may be accessed.

In other words, the augmented reality web environment access link CL (in what follows, access link) according to the embodiment may mean a URL and/or an image that includes the URL (in what follows, URL image) that may access the augmented reality environment based on a predetermined AR library in the web environment.

More specifically, in the embodiment, the application 111 may obtain the access link CL (i.e., URL and/or URL image) matched to the recognized identification code TC from the memory 110 and/or the AR object providing server 200.

Also, the application 111 may provide the obtained access link CL by outputting the access link on the shooted videos of identification code CV.

Also, in the embodiment, the application 111 may provide an augmented reality web environment based on an AR library S111.

Here, in other words, the augmented reality web environment according to the embodiment may mean a predetermined augmented reality environment implemented in the web environment.

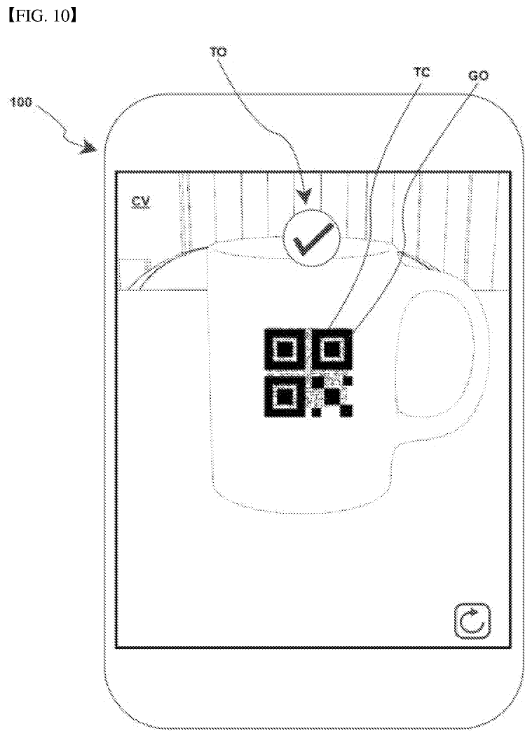

FIG. 10 is an exemplary drawing illustrating an augmented reality web environment based on an AR library according to an embodiment of the present disclosure.

Specifically, referring to FIG. 10, the application 111 according to the embodiment may obtain a predetermined user input (e.g., a touch and/or drag input) based on a provided access link CL.

When a user input based on the access link CL is obtained, the application 111 may move to (access) a web page having the URL corresponding to the access link CL.

Therefore, the application 111 may move to (access) an augmented reality web environment connected to the URL corresponding to the access link CL (i.e., an augmented reality web environment based on an AR library matched to the target identification code TC).

At this time, in the embodiment, the application 111 may obtain the shooted video (in what follows, a second image) including a second target object by re-operating the image sensor after accessing an augmented reality web environment.

In other words, the application 111 may obtain a target criterion object CO which is included in the second image based on an augmented reality web environment.

In other words, in the embodiment, when the application 111 recognizes the matched target criterion object CO on the second image, the application 111 may provide an augmented reality web environment that augments and displays a virtual object (i.e., a target virtual object TO) according to the AR library generated based on the target criterion object CO.

Here, a method for recognizing the target criterion object CO may be the same as the one used for recognizing the target identification code TC. However, since the method for recognizing the target identification code TC is confined to the case where the target object is implemented using a 2D identification code, if the target criterion object CO is a 3D object rather than a 2D object, tracking a target object using the same method may readily reveal a problem.

Therefore, in the embodiment, the application 111 may provide an AR object tracking service for recognizing a 3D target object.

### Method for Providing an AR Object Tracking Service

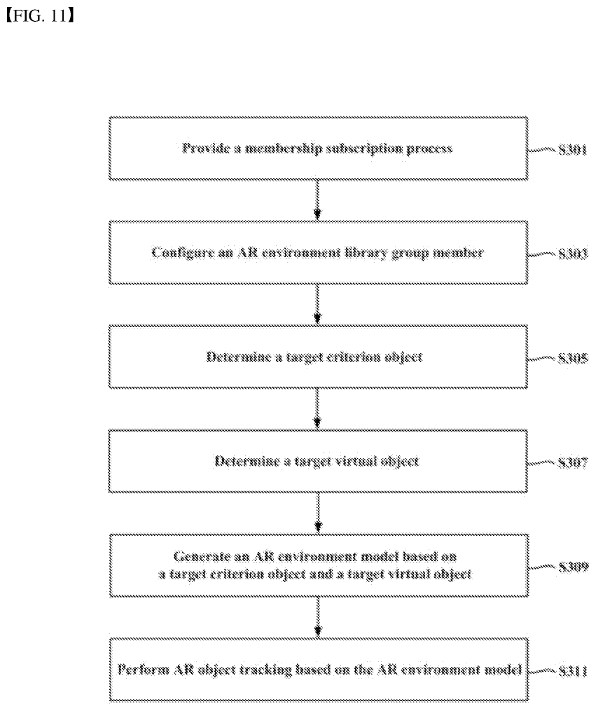

FIG. 11 is a flow diagram illustrating a method for providing an AR object tracking service according to an embodiment of the present disclosure.

Referring to FIG. 11, in the embodiment, the application 111 executed by at least one or more processors of the terminal 100 or operating in the background mode may provide a membership subscription process S301.

Specifically, the application 111 according to the embodiment may provide a membership subscription process that registers user account information on the platform providing an object tracking service (in what follows, a service platform).

More specifically, in the embodiment, the application 111 may provide a user interface through which user account information may be entered (in what follows, a membership subscription interface).

For example, the user account information may include a user ID, password, name, age, gender, and/or email address.

Also, in the embodiment, the application 111 may register the user account information obtained through the membership subscription interface to the service platform in conjunction with the AR object providing server 200.

For example, the application 111 may transmit the user account information obtained based on the membership subscription interface to the AR object providing server 200.

At this time, the AR object providing server 200 which has received the user account information may store and manage the received user account information on the memory module 230.

Therefore, the application 111 may implement the membership subscription process which registers the user account information on the service platform.

Also, in the embodiment, the application 111 may grant use rights for the object tracking service to a user whose user account information has been registered with the service platform.

Also, in the embodiment, the application 111 may configure group members of an AR environment library S303.

Here, the AR environment library according to the embodiment may mean a library that provides at least one AR environment model.

At this time, the AR environment model according to the embodiment may mean a predetermined 3D definition model and a model including a predetermined virtual object anchored to the 3D definition model.

Here, the 3D definition model according to the embodiment may mean a model trained to track the changes in the 6 DoF parameters of a predetermined object.

Specifically, the application 111 according to the embodiment may configure group members with the rights to share the AR environment library (including a track library, which will be described later).

At this time, a group member may be at least one other user who has registered an account on the service platform.

More specifically, in the embodiment, when the application 111 obtains use rights for the object tracking service through the membership subscription service, the application 111 may provide a user interface (in what follows, a member configuration interface) through which a group member may be configured.

Then the application 111 may configure at least one other user as a group member based on the user input obtained from the provided member configuration interface.

Through the operation above, the application 111 may subsequently provide a function of sharing various data (in the embodiment, the AR environment model and/or 3D definition model) among group members based on the service platform.

Also, in the embodiment, the application 111 may determine a target criterion object S305.

Here, a target criterion object according to the embodiment may mean a 3D definition model for the target object for which tracking is to be performed.

In other words, the target criterion object CO may be a model trained to track the changes in the 6 DoF parameters of the target object for which tracking is to be performed.

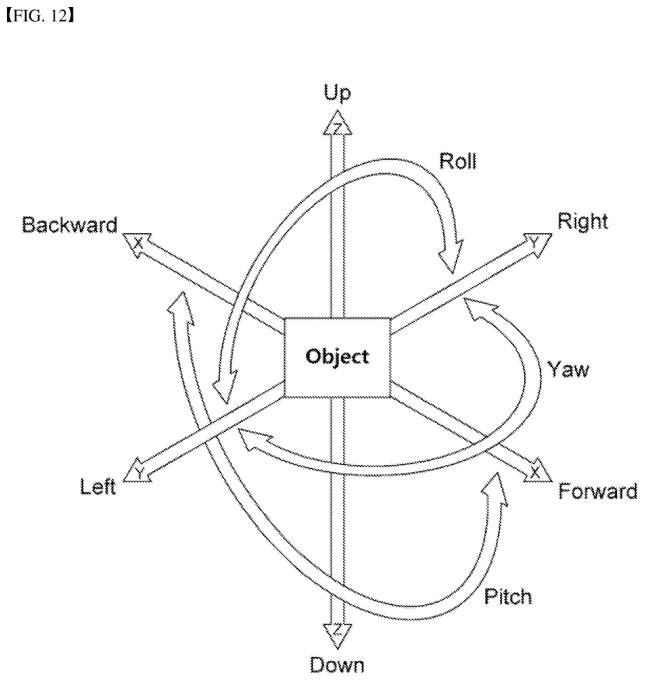

FIG. 12 is an exemplary drawing illustrating 6 degrees of freedom (DoF) parameters according to an embodiment of the present disclosure.

For reference, referring to FIG. 12, 6 degrees of freedom refers to pose information of an object moving in the predetermined 3D space, including six rotational and translational motion elements.

Specifically, 6 DoF parameters may include rotation data (R values) that include measurements of left-to-right rotation (Roll) around X-axis, forward-to-backward rotation (Pitch) around Y-axis, and up-down rotation (Yaw) around Z-axis in the 3D orthogonal coordinate system.

Further, 6 DoF parameters may include translational data (T values) that include measurements of forward/backward, left/right, and up/down translational motions in the 3D orthogonal coordinate system.

Returning to the disclosure, the target criterion object according to the embodiment may include descriptors of the object and distance information corresponding to each descriptor (in what follows, 3D depth data).

The target criterion object may be a model trained to track the changes in the 6 DoF parameters of the object based on the 3D depth data.

More specifically, the application 111 according to the embodiment may determine the target criterion object CO based on 1) a predetermined 3D definition model within a track library.

At this time, the track library according to the embodiment may mean a library that provides at least one 3D definition model.

For example, the preconfigured, predetermined 3D definition model may include a 2D rectangular model, a 3D cube model, and a 3D cylinder model.

Also, in the embodiment, the application 111 may obtain user input that selects at least one from among 3D definition models within the track library.

Also, in the embodiment, the application 111 may read and download a 3D definition model selected according to the user input from the track library.

In this way, the application 111 may determine the 3D definition model according to the user's selection as a target criterion object.

Meanwhile, in the embodiment, the application 111 may determine a target criterion object based on 2) the object shape.

In the embodiment, the object may mean an object contained in a real-time image obtained by capturing the 3D space through the image sensor 161.

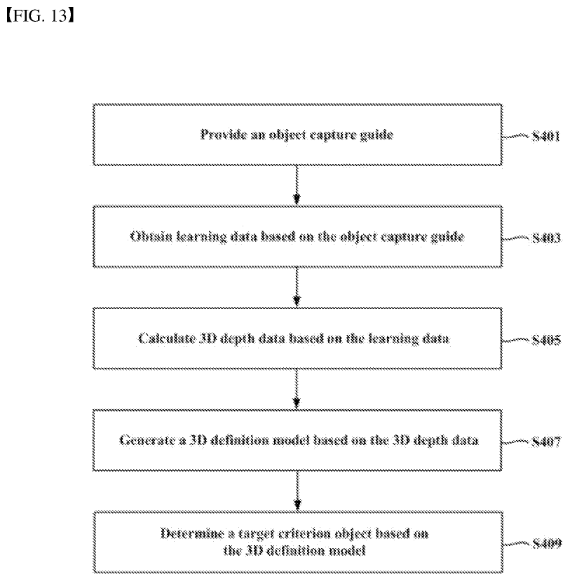

FIG. 13 is a flow diagram illustrating a method for determining a target criterion object from an object according to an embodiment of the present disclosure.

Referring to FIG. 13, the application 111 according to the embodiment may provide an object capture guide when a target criterion object is determined based on an object S401.

Specifically, the application according to the embodiment may provide an object capture guide describing how to capture an object for which tracking is to be performed.

In the embodiment, the object capture guide may include information guiding to capture a target object at least one or more times from at least one or more viewpoints (i.e., camera viewpoints).

Also, in the embodiment, the application 111 may obtain learning data based on the image data captured according to the object capture guide S403.

Here, the learning data according to the embodiment may mean the base data intended for obtaining a target criterion object (3D definition model).

Specifically, in the embodiment, the application 111 may obtain at least one image data of an object captured from at least one viewpoint.

At this time, when one image data is obtained, the application 111 may obtain learning data including the single image data.

On the other hand, when a plurality of image data are obtained, the application 111 may obtain learning data including the plurality of image data and 6 DoF parameters describing the relationships among a plurality of viewpoints from which the plurality of image data are captured.

Also, in the embodiment, the application 111 may calculate the 3D depth data based on the obtained learning data S405.

Here, in other words, the 3D depth data according to the embodiment may mean information that includes individual descriptors of an object and distance values corresponding to the individual descriptors.

In other words, the 3D depth data may be image data for which the ray casting technique is implemented.

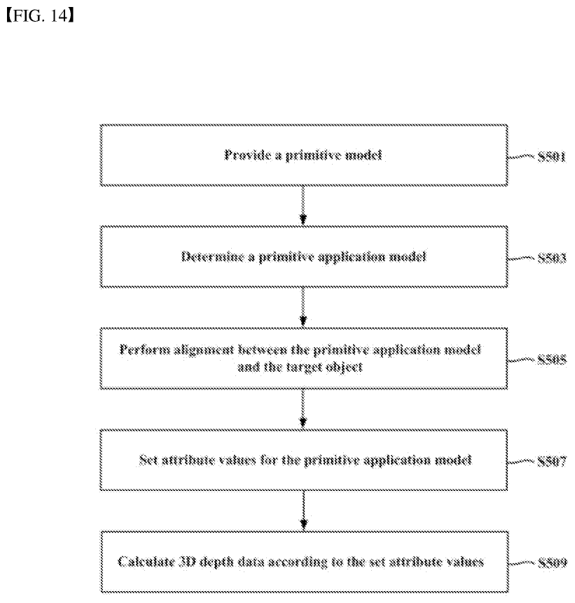

FIG. 14 is a flow diagram illustrating a method for calculating 3D depth data from signal image data according to an embodiment of the present disclosure.

Specifically, referring to FIG. 14, in a first embodiment, 1) when learning data includes single image data (i.e., when 3D depth data are calculated from single image data), the application 111 may provide a primitive model S501.

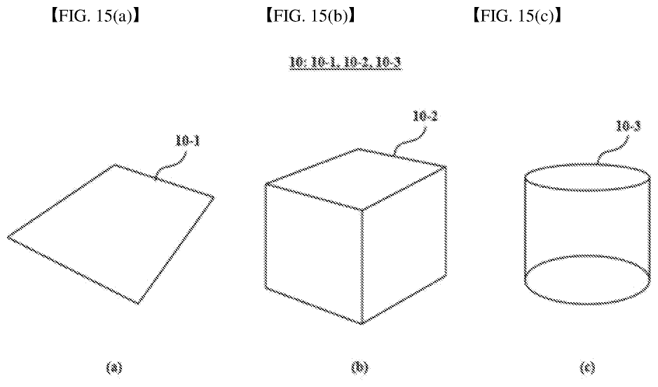

FIG. 15 is an exemplary drawing illustrating a primitive model according to an embodiment of the present disclosure.

Here, referring to FIG. 15, the primitive model 10 according to the embodiment may mean a 2D or 3D model with a preconfigured shape, which are provided as built-in models of the service platform.

In the embodiment, the primitive model 10 may be implemented using a predetermined 2D rectangular model 10-1, 3D cube model 10-2, or 3D cylinder model 10-3.

At this time, in the embodiment, the primitive model 10 may include a plurality of descriptors specifying the model shape and distance information corresponding to each of the plurality of descriptors.

Specifically, in the embodiment, the application 111 may provide a plurality of primitive models 10 according to a predetermined method (e.g., list datatype).

Also, in the embodiment, the application 111 may determine at least one of the provided primitive models 10 as a primitive application model S503.

Here, the primitive application model according to the embodiment may mean the primitive model 10 to be overlaid and displayed on single image data for the purpose of calculating 3D depth data.

Specifically, in the embodiment, the application 111 may provide a user interface (in what follows, a primitive model 10 selection interface) through which at least one of a plurality of primitive models 10 may be selected.

Also, the application 111 may determine the primitive model 10 selected according to the user input based on the primitive model 10 selection interface as a primitive application model.

In other words, in the embodiment, the application 111 may calculate 3D depth data using the primitive model 10 determined to have the most similar shape to the object according to the user's cognitive judgment.

Through the operation above, the application 111 may improve data processing efficiency and user convenience in the 3D depth data calculation process.

In another embodiment, the application 111 may perform semantic segmentation on a target object within single image data in conjunction with a predetermined deep learning neural network.

Then the application 111 may detect the edge of the target object through the semantic segmentation performed.

Also, the application 111 may compare the edge shape of a detected target object with the edge shape of each of the plurality of primitive models 10.

Also, the application 111 may select a primitive model 10 having a similarity higher than a predetermined threshold (e.g., a similarity higher than a preset ratio (%)) with the edge shape of a target object from a comparison result.

Then the application 111 may provide a user interface (in what follows, a recommendation model selection interface) through which one of the selected primitive models (in what follows, primitive recommendation models) may be selected as a primitive application model.

Also, the application 111 may determine the primitive recommendation model selected according to the user input based on the recommendation model selection interface as a primitive application model.

In this way, the application 111 may automatically detect and provide a primitive model 10 that has the most similar shape to the target object among the plurality of primitive models 10.

Accordingly, the application 111 may support calculating 3D depth data using the primitive model 10 determined based on objective data analysis.

Also, in the embodiment, the application 111 may perform alignment between the primitive application model and the target object S505.

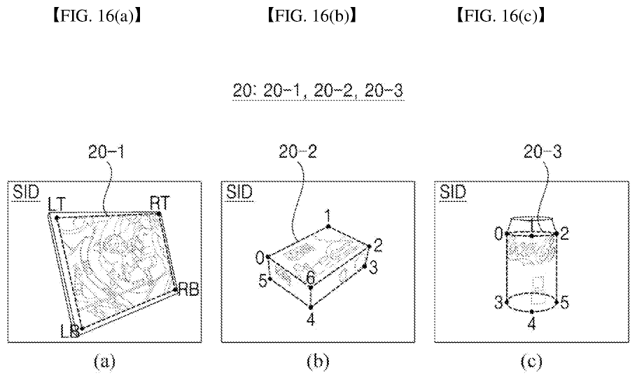

FIG. 16 is an exemplary drawing illustrating a method for aligning a primitive application model and a target object according to an embodiment of the present disclosure.

Specifically, referring to FIG. 16, the application 111 according to the embodiment may perform alignment so that the edge shape of a primitive application model corresponds to the edge shape of a target object, achieving a similarity exceeding a predetermined threshold (e.g., a preconfigured ratio (%)).

More specifically, in the embodiment, the application 111 may display the primitive application model 20: 20-1, 20-2, 20-3 by overlaying the primitive application model at a predetermined position within single image data (SID).

In the embodiment, the application 111 may overlay and display the primitive application model 20 at a position within a predetermined radius from a target object within the single image data (SID).

Also, the application 111 may place each descriptor of the overlaid primitive application model 20 at each predetermined point on the target object.

At this time, in the embodiment, when the position of each descriptor of the primitive application model 20 displayed on the single image data (SID) is changed, the primitive application model 20 may change its shape according to the edges changed in conjunction with the change status of the changed descriptors.

In other words, the shape of the primitive application model 20 may be adjusted to have a shape similar to that of the target object by shape deformation according to a position change of each descriptor.

Returning to the description of the embodiment, in the embodiment, the application 111 may place each descriptor of the primitive application model 20 at each predetermined point on the target object based on user input.

Specifically, the application 111 may provide a user interface (in what follows, align interface) that may change the position coordinates of descriptors of the primitive application model 20 displayed on single image data (SID).

Also, the application 111 may position each descriptor included in the primitive application model 20 at each predetermined point on the target object according to user input based on the align interface.

In other words, the application 111 may support the user to freely place each descriptor of the primitive application model 20 at each predetermined point on the target object deemed to correspond to the descriptor.

Accordingly, the application 111 may perform alignment to ensure that the edge shape of the primitive application model 20 and the edge shape of the target object have a similarity greater than a predetermined threshold.

In another embodiment, the application 111 may automatically place each descriptor of the primitive application model 20 at each predetermined point on the target object.

At this time, the application 111 may automatically place each descriptor of the primitive application model 20 at each predetermined point on the target object so that the primitive application model 20 is aligned with the target object.

Specifically, the application 111 may automatically place each descriptor of the primitive application model 20 at each predetermined position on the target object so that the primitive application model 20 is aligned with the target object.

The embodiment of the present disclosure does not specify or limit the algorithm itself for deriving the position coordinates of each descriptor.

Also, the application 111 may change the position of each descriptor of the primitive application model 20 according to the derived position coordinates of each descriptor.

Therefore, the application 111 may perform alignment between the primitive application model 20 and the target object.

Accordingly, the application 111 may more easily and quickly perform alignment that relates the shapes of the primitive application model 20 to those of the target object.

At this time, in the embodiment, the application 111 may determine the area occupied by the primitive application model 20 aligned with the target object as a target object area.

Then the application 111 may calculate 3D depth data based on the determined target object area.

Also, in the embodiment, the application 111 may set attribute values for the primitive application model 20 for which alignment is performed S507.

Here, the attribute values according to the embodiment may be information that sets various parameter values that specify the shape of a predetermined object.

In the embodiment, the attribute values may be information that sets values such as scale, diameter, and/or radius for each edge included in a predetermined object.

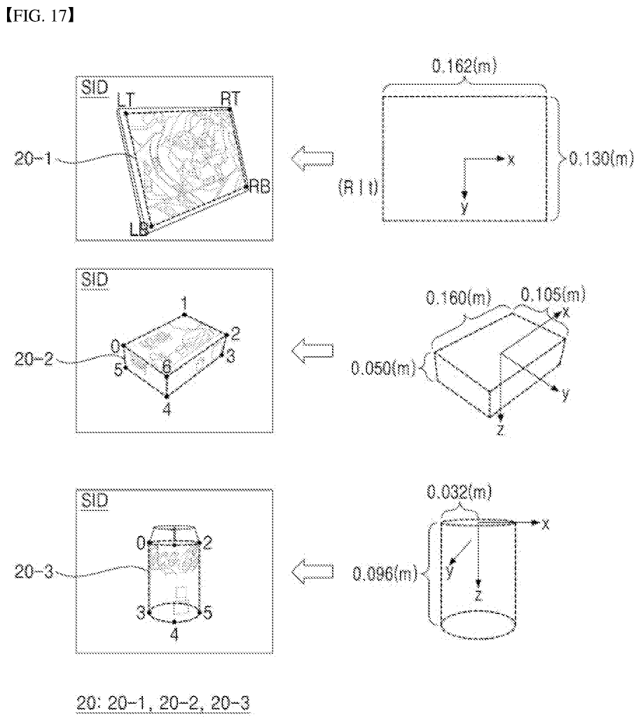

FIG. 17 is an exemplary drawing illustrating a method for setting attribute values of a primitive application model according to an embodiment of the present disclosure.

Specifically, referring to FIG. 17, the application 111 according to the embodiment may set the attribute values of the primitive application model 20 to be identical to the attribute values actually measured for the target object (here, an object).

In other words, the application 111 may set the attribute values of the primitive application model 20 based on the attribute values measured for the actual object.

More specifically, the application according to the embodiment may provide a user interface (in what follows, a model attribute interface) through which the attribute values of the primitive application model 20 may be set.

Additionally, the application 111 may set attribute values of the primitive application model 20 based on user input based on the model attribute interface.

At this time, in a preferred embodiment, the user input for setting the attribute values is performed based on accurate measurements of attribute values for the actual object.

In other words, in the embodiment, the user may measure attribute values such as scale, diameter, and/or radius for each predetermined edge of a real object and apply user input that sets the attribute values of the primitive application model 20 based on the measured attribute values.

Also, in the embodiment, the application 111 may calculate 3D depth data based on set attribute values S509.

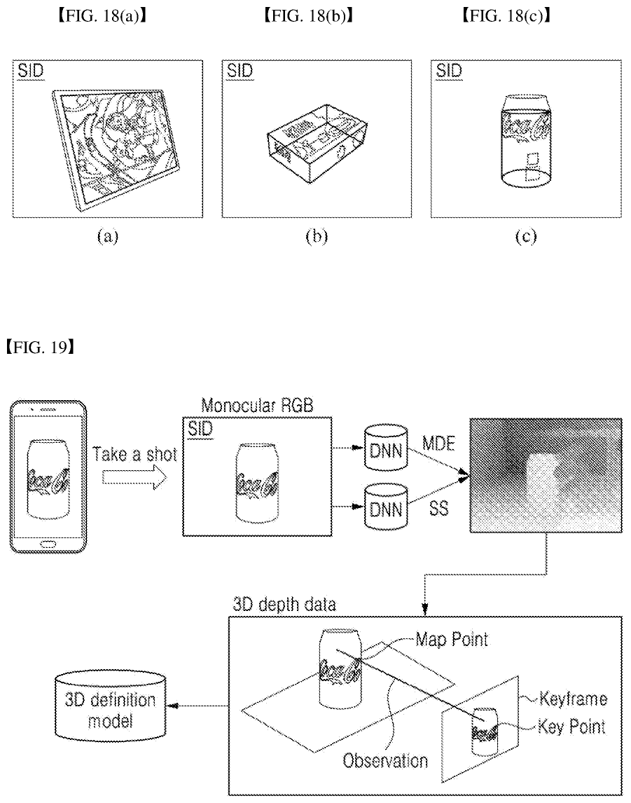

FIG. 18 is an exemplary drawing illustrating a method for calculating 3D depth data based on the attribute values of a primitive application model 20 according to an embodiment of the present disclosure.

In other words, referring to FIG. 18, the application 111 according to the embodiment may calculate 3D depth data that include each descriptor of a target object and a distance value corresponding to the descriptor based on the attribute values (in what follows, current attribute value information) set for the primitive application model 20.

Specifically, in the embodiment, the application 111 may read, from the memory 110, a plurality of descriptors initially set for the primitive application model 20 and distance information for each of the plurality of descriptors (in what follows, initial attribute value information).

Also, the application 111 may calculate 3D depth data through comparison between the read initial attribute value information and the current attribute value information.

For example, the application 111 may obtain the initial distance value for the first edge of the primitive application model 20 based on the initial attribute value information.

Also, in the embodiment, the application 111 may obtain the current length value (i.e., scale value) for the first edge of the primitive application model 20 based on current attribute value information.

Also, in the embodiment, the application 111 may perform a comparison between the obtained initial distance value and the current length value.

Also, in the embodiment, the application 111 may estimate the distance value according to the current length value in comparison to the initial distance value.

Therefore, in the embodiment, the application 111 may calculate 3D depth data based on the estimated current distance value.

In this way, the application 111 according to the embodiment may accurately and efficiently estimate and reconstruct 3D information (in the embodiment, 3D depth data) for tracking a target object from single image data.

FIG. 19 is a conceptual drawing illustrating another method for calculating 3D depth data from single image data (SID) according to an embodiment of the present disclosure.

Meanwhile, referring to FIG. 19, when learning data includes single image data (SID) (i.e., when 3D depth data are obtained based on the single image data (SID)), the application 111 according to a second embodiment may obtain 3D depth data based on the single image data (SID) in conjunction with a predetermined deep learning neural network.

Specifically, the application 111 according to the embodiment may perform monocular depth estimation (MDE) based on single image data (SID) in conjunction with a predetermined, first deep learning neural network (e.g., CNN).

Here, in other words, monocular depth estimation (MDE) may mean deep learning that uses one image data as input and three-dimensional depth data for one input image data as output.

More specifically, in the embodiment, the application 111 may provide single image data (SID) to the first deep learning neural network as input data.

Then, the first deep learning neural network may perform monocular depth estimation (MDE) based on the provided input data (i.e., single image data (SID)).

The first deep learning neural network may obtain 3D depth data as output data of the monocular depth estimation (MDE) performed.

Also, the first deep learning neural network may provide the obtained 3D depth data to the application 111.

Then the application 111 may obtain 3D depth data based on the single image data (SID).

Therefore, the application 111 may readily obtain 3D information (in the embodiment, 3D depth data) for target object tracking from single image data by utilizing a pre-built deep learning algorithm without the need for additional efforts.

At this time, in the embodiment, the application 111 may perform semantic segmentation (SS) based on single image data (SID) in conjunction with a predetermined second deep learning neural network (e.g., CNN).

Here, in other words, semantic segmentation (SS) may refer to a deep learning technique that segments and recognizes each object included in a predetermined image in physically meaningful units.

Then the application 111 may determine the target object area within the single image data (SID).

Specifically, in the embodiment, the application 111 may provide the single image data (SID) to the second deep learning neural network as input data.

Then the second deep learning neural network may perform semantic segmentation (SS) based on the provided input data (i.e., single image data (SID)).

Also, the second deep learning neural network may obtain information (in what follows, object area information) representing the area occupied by each of at least one object included in the single image data (SID) as output data of the semantic segmentation (SS) performed.

Also, the second deep learning neural network may provide the obtained object area information to the application 111.

Then the application 111 may obtain at least one target object candidate area based on the provided object area information.

Specifically, the application 111 may obtain at least one target object candidate area based on the object area information by setting the area occupied by each object within the object area information as the corresponding target object candidate area.

Also, the application 111 may determine the target object area based on at least one target object candidate area obtained.

In the embodiment, the application 111 may provide a user interface (in what follows, target object area setting interface) through which a user may choose one from at least one target object candidate area.

Also, the application 111 may determine a target object candidate area selected based on the user input through the target object area setting interface as a target object area.

In another embodiment, the application 111 may determine one of at least one target object candidate area as a target object area based on a preconfigured criterion (e.g., a target object candidate area having the largest area).

Also, the application 111 may calculate 3D depth data based on the determined target object area.

In this way, the application 111 may improve data processing efficiency for target object area recognition and improve user convenience by determining the target object area within single image data (SID) using a deep learning algorithm.

At this time, depending on the embodiments, the application 111 may perform monocular depth estimation (MDE) and semantic segmentation (SS) in parallel.

In other words, the application 111 may simultaneously obtain 3D depth data and determine a target object area within single image data (SID) in conjunction with the first and second deep learning neural networks.

Accordingly, the application 111 may more quickly and accurately obtain 3D depth data based on single image data (SID).

In the description above, it is assumed that monocular depth estimation (MDE) is performed based on the first deep learning neural network, and semantic segmentation (SS) is performed based on the second deep learning neural network; however, various embodiments may also be possible such that monocular depth estimation (MDE) and semantic segmentation (SS) are performed based on a third deep learning neural network obtained from integration of the first and second deep learning neural networks.

Also, the embodiment of the present disclosure does not specify or limit the deep learning algorithm itself, which performs monocular depth estimation (MDE) and/or semantic segmentation (SS), and the application 111 according to the embodiment may perform the functional operations described above based on various disclosed algorithms.

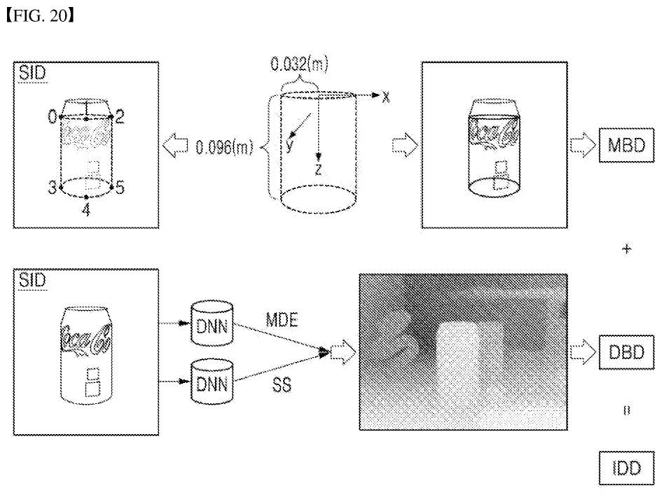

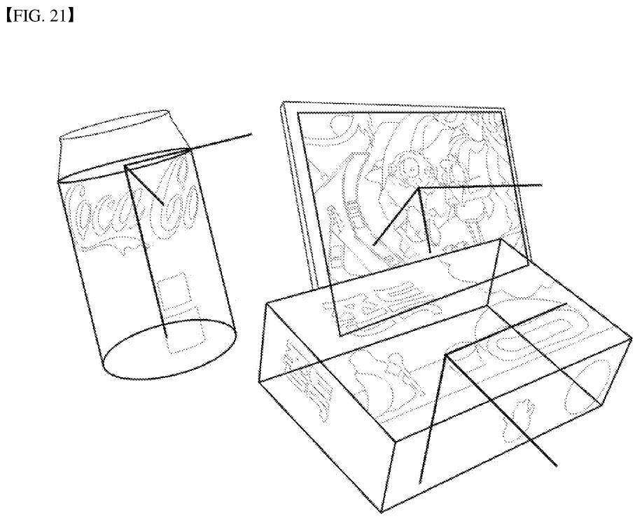

FIG. 20 is a conceptual drawing illustrating a method for generating 3D integrated depth data according to an embodiment of the present disclosure.

Meanwhile, referring to FIG. 20, the application 111 according to the embodiment may generate 3D integrated depth data (IDD) based on the primitive model 10 based 3D depth data (MBD: in what follows, model-based depth data) and deep learning neural network-based 3D depth data (DBD: in what follows, deep learning-based depth data).

Here, 3D integrated depth data (IDD) according to the embodiment may mean 3D depth data obtained by integration of model-based depth data (MBD) and deep learning-based depth data (DBD) according to a preconfigured method.

Specifically, the application 111 according to the embodiment may obtain model-based depth data (MBD) and deep learning-based depth data (DBD) based on single image data (SID) when learning data includes the single image data (SID) (in other words, when 3D depth data is obtained based on the single image data (SID)).

At this time, the descriptions based on FIG. 14 apply to the descriptions of a specific method for obtaining the model-based depth data (MBD), and the descriptions based on FIG. 19 apply to the descriptions of a specific method for obtaining the deep learning-based depth data (DBD).

Also, the application 111 according to the embodiment may combine the obtained model-based depth data (MBD) and deep learning-based depth data (DBD) according to a preconfigured method.

In the embodiment, the application 111 may detect descriptors having mutually corresponding position coordinates (in what follows, matching descriptors) among a plurality of descriptors within the model-based depth data (MBD) and a plurality of descriptors within the deep learning-based depth data (DBD).

Also, the application 111 may detect a distance value corresponding to a matching descriptor within the model-based depth data (MBD) (in what follows, a first depth value).

Also, the application 111 may detect a distance value corresponding to a matching descriptor within the deep learning-based depth data (DBD) (in what follows, a second depth value).

Also, the application 111 may obtain an integrated depth value obtained by combining the detected first and second depth values into a single value according to a preconfigured method (e.g., predetermined arithmetic operations).

Also, the application may set the obtained integrated depth value as a distance value of the matching descriptor.

Also, in the embodiment, the application 111 may detect and obtain the remaining descriptors excluding the matching descriptor (in what follows, attribute descriptors) from among a plurality of descriptors within the model-based depth data (MBD) and a plurality of descriptors within the deep learning-based depth data (DBD).

Also, in the embodiment, the application 111 may generate 3D integrated depth data (IDD) which includes both the matching descriptor and the attribute descriptor obtained.

However, the embodiment described above is only an example, and the embodiment of the present disclosure does not specify or limit the method itself, which combines the model-based depth data (MBD) and the deep learning-based depth data (DBD) into one 3D depth data (i.e., 3D integrated depth data (IDD)).

In other words, the application 111 may generate 3D depth data (i.e., 3D integrated depth data (IDD)) that reflects varying characteristics of a plurality of 3D depth data obtained from single image data (SID) using diverse methods (in the embodiment, 3D depth data obtained by utilizing the primitive model 10 (i.e., model-based depth data (MBD) and 3D depth data obtained by utilizing a predetermined deep learning neural network (i.e., deep learning-based depth data (DBD))).

Through the operation above, the application may further improve the accuracy and reliability of the 3D depth data obtained from the single image data (SID).

In the description above, for the purpose of effectiveness, the embodiments (i.e., the first and second embodiments) were treated separately; however, various other embodiments may be equally possible such that at least part of the embodiments are combined and operated together in a synergistic manner.

On the other hand, 2) when learning data includes a plurality of image data (i.e., when 3D depth data are calculated based on a plurality of image data), the application 111 according to the embodiment may calculate 3D depth data for each of the plurality of image data in the same way as in the first embodiment and/or the second embodiment.

In other words, the application 111 may obtain a plurality of 3D depth data by calculating 3D depth data corresponding to each of the plurality of image data.

At this time, depending on the embodiments, the application 111 may generate 3D integrated depth data (IDD) for each of the plurality of image data based on the model-based depth data (MBD) and the deep learning-based depth data (DBD) for each of the plurality of image data.

In what follows, descriptions that overlap the descriptions above may be summarized or omitted.

Specifically, the application 111 according to the embodiment may obtain the model-based depth data (MBD) and the deep learning-based depth data (DBD) based on each of a plurality of image data.

Also, in the embodiment, the application 111 may combine the model-based depth data (MBD) and deep learning-based depth data (DBD) obtained for each image data according to a preconfigured method.

Accordingly, the application 111 may generate 3D integrated depth data (IDD) for each image data.

Through the operation above, the application 111 may later generate a 3D definition model based on more detailed 3D depth data and improve the quality of the 3D depth data.

Returning to FIG. 13, in the embodiment, the application 111 may generate a 3D definition model based on the calculated 3D depth data (which are included in the 3D integrated depth data (IDD) depending on the embodiments) S407.

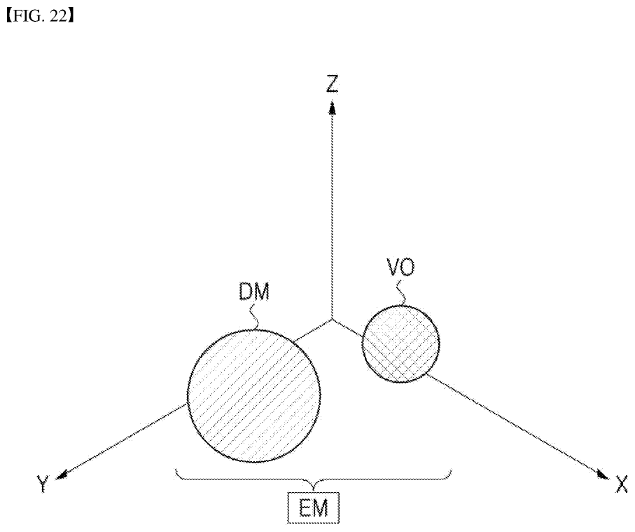

FIG. 21 is an exemplary drawing illustrating a 3D definition model according to an embodiment of the present disclosure.

Here, referring again to FIG. 21, the 3D definition model according to the embodiment may mean a model trained to track the changes in the 6 DoF parameters of a predetermined object.

In other words, in the embodiment, the application 111 may generate a 3D definition model trained to track the changes in the 6 DoF parameters of a target object for which tracking is to be performed by generating a 3D definition model based on 3D depth data.

Specifically, in the embodiment, the application 111, in conjunction with a predetermined deep learning neural network, may perform deep learning (in what follows, the first 3D information reconstruction deep learning) by using 3D depth data (i.e., descriptors for a target object and distance values corresponding to the respective descriptors) as input data and by using a 3D definition model based on the 3D depth data as output data.

At this time, the embodiment of the present disclosure does not specify or limit the deep learning algorithm itself, which performs 3D information reconstruction; the application 111 may perform functional operations for 3D information reconstruction deep learning based on various well-known deep learning algorithms (e.g., deep plane sweep network (DPSNet)) and/or attention guided network (AGN).

Therefore, in the embodiment, the application 111 may generate a 3D definition model according to 3D depth data.

At this time, in the embodiment, when a plurality of 3D depth data exist (i.e., when a plurality of 3D depth data are calculated using learning data that include a plurality of image data), the application 111 may generate each 3D definition model based on the corresponding 3D depth data in the same manner as described above.

In other words, the application 111 may generate a plurality of 3D definition models based on a plurality of 3D depth data.

Also, the application 111 may combine a plurality of 3D definition models into one 3D definition model according to a preconfigured method.

In what follows, for the purpose of effective description, a plurality of 3D definition models are limited to a first 3D definition model and a second 3D definition model; however, the present disclosure is not limited to the specific example.

In the embodiment, the application 111 may detect descriptors having mutually corresponding position coordinates (in what follows, common descriptors) among a plurality of descriptors within the first 3D definition model and a plurality of descriptors within the second 3D definition model.

Also, the application 111 may detect a distance value corresponding to a common descriptor within the first 3D definition model (in what follows, a first distance value).

Also, the application 111 may detect a distance value corresponding to a common descriptor within the second 3D definition model (in what follows, a second distance value).

Also, the application 111 may obtain an integrated distance value obtained by combining the detected first and second distance values into a single value according to a preconfigured method (e.g., averaging operation).

Also, the application may set the obtained integrated distance value as a distance value of the common descriptor.

Also, in the embodiment, the application 111 may detect and obtain the remaining descriptors excluding the common descriptor (in what follows, specialized descriptors) from among a plurality of descriptors within the first 3D definition model and a plurality of descriptors within the second 3D definition model.

Also, in the embodiment, the application 111 may generate 3D integrated definition model which includes both the common descriptor and the specialized descriptor obtained.

Therefore, the application 111 may combine the first 3D definition model and the second 3D definition model into one 3D definition model.

However, the embodiment described above is only an example, and the embodiment of the present disclosure does not specify or limit the method itself, which combines a plurality of 3D definition models into one 3D definition model.

In another embodiment, when a plurality of 3D depth data exist (i.e., when a plurality of 3D depth data are calculated using learning data that include a plurality of image data), the application 111 may perform deep learning (in what follows, the second 3D information reconstruction deep learning) in conjunction with a predetermining deep learning neural network by using a plurality of 3D depth data as input data and by using a single 3D definition model based on a plurality of 3D depth data as output data.

Thus, in the embodiment, the application 111 may generate one 3D definition model according to a plurality of 3D depth data.

In this way, the application 111 may expand the area for precise tracking of a target object by creating a 3D definition model that reflects a plurality of 3D depth data according to a plurality of image data.

At this time, depending on the embodiments, the application 111 may register (store) and manage the generated 3D definition model on the AR project and/or AR library.

Accordingly, the application 111 may enable the user to utilize not only the built-in 3D definition models provided on a service platform but also the 3D definition models newly created by the user on the service platform in various ways.

Also, in the embodiment, the application 111 may determine the generated 3D definition model as a target criterion object S409.

In other words, based on the 3D definition model generated as described above, the application 111 may determine a target criterion object that includes each descriptor for a target object within a real-time captured image (here, an object) and distance value information corresponding to the descriptor.

Returning again to FIG. 11, in the embodiment, the application 111 may determine the target virtual object S307.

Here, a target virtual object according to the embodiment may mean a 3D virtual object to be augmented and displayed in conjunction with the target criterion object.

At this time, the virtual object according to the embodiment may include 3D coordinate information that specifies the virtual object's 6 DoF parameters in 3D space.

Specifically, in the embodiment, the application 111 may provide a library (in what follows, a virtual object library) that provides at least one virtual object.

Also, the application 111 may obtain user input for selecting at least one of the virtual objects included in the virtual object library.

Accordingly, the application 111 may determine the virtual object selected according to the user input as the target virtual object.

In another embodiment, the application 111 may provide a user interface (in what follows, a virtual object upload interface) through which a user may upload at least one virtual object onto the service platform.

Also, the application 111 may determine the virtual object uploaded to the service platform based on user input through the virtual object upload interface as a target virtual object.

At this time, depending on the embodiments, the application 111 may determine whether a virtual object uploaded through the virtual object upload interface meets preconfigured specifications.

Also, the application 111 may upload a virtual object determined to meet preconfigured specifications onto the service platform.

Also, in the embodiment, the application 111 may generate an AR environment model based on the target criterion object and the target virtual object S309.

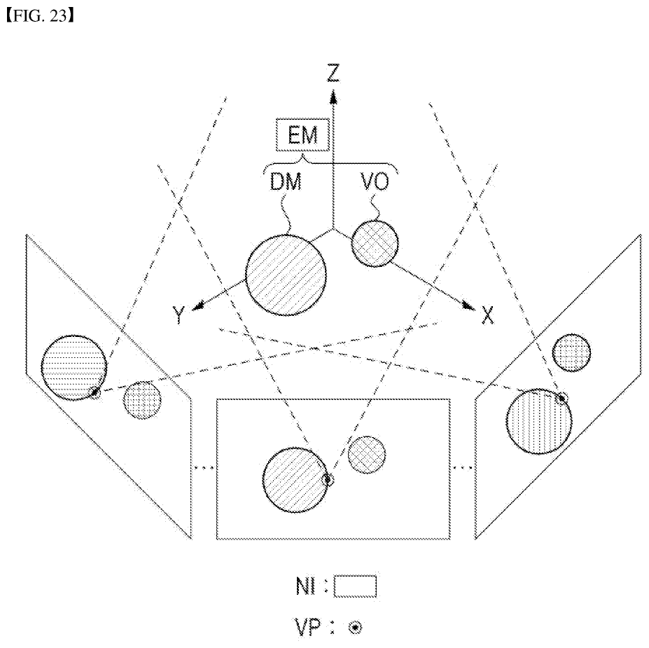

FIG. 22 is an exemplary drawing illustrating an AR environment model according to an embodiment of the present disclosure.

Here, referring to FIG. 22 again, the AR environment model EM according to the embodiment means a model that includes a predetermined 3D definition model and a predetermined virtual object anchored to the 3D definition model.

Specifically, the application 111 according to the embodiment may perform anchoring between the target criterion object and the target virtual object.

Here, for reference, anchoring according to the embodiment may mean a functional operation for registering a target criterion object to a target virtual object so that the changes in the 6 DoF parameters of the target criterion object are reflected in the changes in the 6 DoF parameters of the target virtual object.

More specifically, the application 111 may perform anchoring between the target criterion object and the target virtual object based on the 3D depth data of the target reference object and the 3D coordinate information of the target virtual object.

At this time, the application 111 according to the embodiment may perform an anchoring process based on various well-known algorithms, where the embodiment of the present disclosure does not specify or limit the algorithm itself for performing the anchoring process.

Therefore, in the embodiment, the application 111 may generate an AR environment model EM including a target criterion object and a target virtual object anchored with respect to the target criterion object.

Also, in the embodiment, the application 111 may register (store) and manage the created AR environment model EM on the AR environment library.

In other words, the application 111 may enable the user to utilize the AR environment model EM generated through the user's terminal 100 on the service platform in various ways (e.g., object tracking, virtual object augmentation, and/or production of a new AR environment model EM.

Also, in the embodiment, the application 111 may perform AR object tracking based on the AR environment model EM S311.

FIG. 23 is an exemplary drawing illustrating AR object tracking according to an embodiment of the present disclosure.

Here, referring to FIG. 23, AR object tracking according to the embodiment may mean a functional operation for tracking changes in the 6 DoF parameters of a virtual object augmented and displayed on predetermined image data (captured image).

Specifically, the application 111 according to the embodiment may provide an AR environment library that provides at least one AR environment model EM.

Also, the application 111 may provide a user interface (in what follows, an AR environment setting interface) through which the user may select at least one of at least one AR environment model EM provided through the AR environment library.

Also, the application 111 may read and download an AR environment model selected according to user input (in what follows, a first AR environment model) based on the AR environment setting interface from the AR environment library.

Therefore, the application 111 may build an AR object tracking environment based on the first AR environment model.

To continue the description, in the embodiment, the application 111 may obtain a new captured image NI shooting a predetermined 3D space from a predetermined viewpoint in conjunction with the image sensor 161.

Also, in the embodiment, the application 111 may detect a target object (in what follows, a first tracking object) within the new captured image NI based on the first AR environment model.

At this time, the application 111 may detect an object corresponding to a target criterion object of the first AR environment model (in what follows, a first target criterion object) among at least one object included in the new captured image NI as a first tracking object.

Also, in the embodiment, the application 111 may augment and display a predetermined virtual object VO on the new captured image NI based on the first AR environment model.

Specifically, the application 111 may augment and display the target virtual object (in what follows, the first target virtual object) of the first AR environment model on the new captured image NI.

At this time, the application 111 may augment and display the first target virtual object on the new captured image NI based on the anchoring information between the first target criterion object and the first target virtual object of the first AR environment model.

Specifically, according to the anchoring information between the first target criterion object and the first target virtual object of the first AR environment model, the application 111 may augment and display the first target virtual object at a predetermined position based on the first tracking object within the new captured image NI.

In other words, the application 111 may augment and display a first virtual object at a position where anchoring information between a first target criterion object and a first target virtual object within the first AR environment model and anchoring information between a first tracking object and a first target virtual object within the new captured image NI are implemented in the same manner.

Therefore, provided that the user constructs an AR environment model EM for a desired target object on the user's working environment, the application 111 may detect the target object within a specific captured image, track changes in the 6 DoF parameters of the detected target object TO and each virtual object anchored to the target object according to a preconfigured method, and display the target object and the virtual object using a shape corresponding to the tracked changes in the 6 DoF parameters.

Meanwhile, in the embodiment, the application 111 may share an AR environment library (including a track library) in conjunction with the terminal 100 of a group member.

Specifically, the application 111 may share the AR environment library with at least one group member through the service platform.

Here, in other words, a group member according to the embodiment may mean another user who has the rights to share the AR environment library (including a track library) among other users who have registered their account on the service platform.

At this time, depending on the embodiments, the application 111 may set whether to allow sharing of each AR environment model EM within the AR environment library among group members.

In the embodiment, the application 111 may provide a user interface (in what follows, a group sharing setting interface) that may set whether to allow sharing of a predetermined AR environment model EM among group members.

Also, the application 111 may set whether to enable or disable group sharing of a predetermined AR environment model EM according to user input through the group sharing setting interface.

Also, the application 111 may share the AR environment model EM configured for group sharing with at least one group member.

At this time, in the embodiment, the AR environment model EM for which group sharing is allowed may be automatically synchronized and shared within a group in real-time through a group-shared AR environment library on the service platform.

Also, in the embodiment, the group shared AR environment model EM may be read and downloaded from the group shared AR environment library based on user (i.e., other user) input from the group member's terminal 100.

As described above, the application 111 may implement AR object tracking for a target object desired by the user using a pre-generated AR environment model EM.

Through the operation above, the application 111 may more efficiently and accurately track changes in the 6 DoF parameters of a virtual object augmented based on a target object within predetermined image data.

Accordingly, the application 111 may augment and display the virtual object on the image data according to a clear posture with relatively little data processing.

As a result, regardless of whether the target object is implemented as a 2D identification code, a 2D image, and/or a 3D definition model, the application 111 according to the embodiment may determine a target criterion object of the same shape as that of the actual object.

Also, in the embodiment, the application 111 may provide an augmented reality web environment that augments and displays a target virtual object TO on a determined target criterion object CO.

At this time, in the embodiment, the application 111 may track the target virtual object TO within the connected augmented reality web environment according to changes in the viewpoint from which the shooted videos of identification code CV is obtained.

In other words, the application 111 determine 6 DoF and scale parameters of a target virtual object TO provided through the connected augmented reality web environment according to the change of the viewpoint from which the shooted videos of identification code CV is obtained.

Specifically, in the embodiment, the application 111 may track changes in the 6 DoF and scale parameters of the target criterion object CO in the shooted videos of identification code CV according to the change in the viewpoint for capturing the identification code.

Also, the application 111 may determine the 6 DoF and scale parameters of a target virtual object TO within the connected augmented reality web environment according to the changes in the 6 DoF and scale parameters of the target criterion object CO obtained through tracking.

At this time, the application 111 may determine the 6 DoF and scale parameters of the target virtual object TO based on the anchoring information of the AR library matched to the target criterion object CO.

In other words, the application 111 may determine the 6 DoF and scale parameters of the target virtual object TO according to the changes in the 6 DoF and scale parameters of the target criterion object CO tracked, based on a relative anchoring relationship established between the target criterion object CO and the target virtual object TO generated based on the criterion object CO.

Also, in the embodiment, the application 111 may provide the target virtual object TO following the determined 6 DoF and scale parameters through augmented display on the augmented reality web environment connected through a connection link CL.

As described above, the embodiment of the present disclosure may recognize an identification code implemented as a graphic image or a real object, provide an augmented reality web environment constructed based on the recognized identification code, and track a virtual object according to a criterion object when the criterion object is recognized within the provided augmented reality web environment.

Therefore, the application 111 may provide an augmented reality environment easily and conveniently through the web once a predetermined identification code is recognized, without involving environmental factors for implementing the augmented reality environment (e.g., installation of a separate software program).

Meanwhile, in the embodiment, the application 111 may obtain a predetermined user input for a target virtual object TO in the augmented reality web environment.

In the embodiment, the application 111 may obtain a target object (in the embodiment, the target identification code TC and the target criterion object CO) within the augmented reality web environment and/or a first user input for the target virtual object TO (e.g., a touch and/or drag input).

Then, the application 111 may execute an event functional operation corresponding to the obtained user input based on the interaction information of the AR library that is matched to the target object.

In other words, in the embodiment, the application 111 may perform a preconfigured first event (e.g., access to a specific web page) functional operation with respect to the obtained first user input, based on the interaction information of the AR library matched to the target object.

As described above, the application 111 may not only augment and display a specific virtual object simply through an AR object providing service but also further provide various functional operations based on the augmented virtual object or target identification code TC, thereby expanding utilization areas and further improving quality of the AR object providing service.

Meanwhile, in the embodiment, the application 111 may provide an object tracking service that supports performance improvement of augmented reality-based object tracking when the target object is implemented as a 3D definition model.

### Method for Object Tracking for Augmented Reality

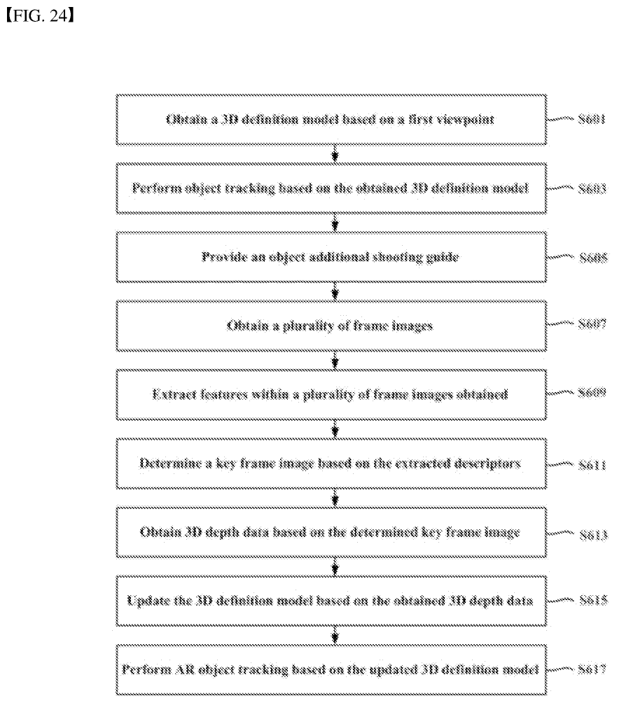

FIG. 24 is a flow diagram illustrating an object tracking method for augmented reality according to an embodiment of the present disclosure.

Referring to FIG. 24, the application 111 according to the embodiment may obtain a 3D definition model based on a first viewpoint S601.

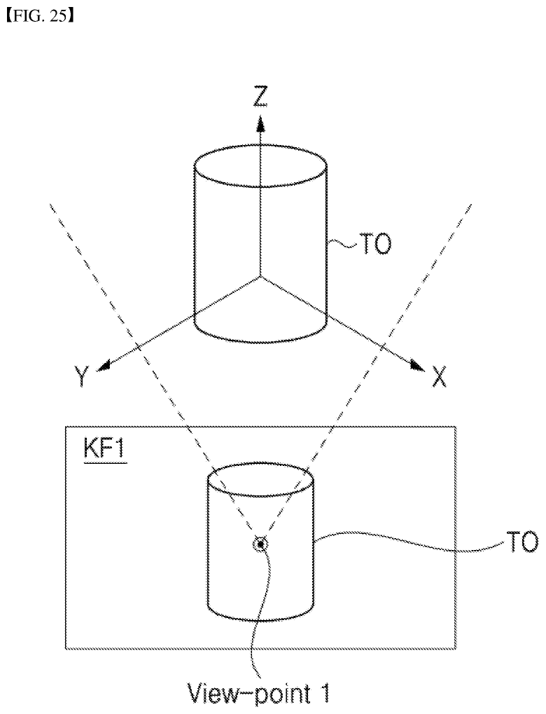

FIG. 25 is an exemplary drawing illustrating a method for obtaining a 3D definition model based on a first viewpoint according to an embodiment of the present disclosure.

Specifically, referring to FIG. 25, the application 111 according to the embodiment may obtain a 3D definition model based on a predetermined first viewpoint (i.e., a first camera viewpoint) by following the process according to FIG. 5 described above.

More specifically, in the embodiment, the application 111 may provide an object shooting guide that guides how to shoot a target object TO (here, object) for which tracking is to be performed.

Also, the application 111 may obtain image data KF 1 (in what follows, a first key frame image) by capturing the target object TO from the first viewpoint based on the object shooting guide.

Also, the application 111 may perform a process according to the first embodiment (the 3D depth data calculation process based on a primitive model) and/or the second embodiment (the 3D depth data calculation process based on a deep learning neural network) described based on the obtained first key frame image KF 1.

Accordingly, the application 111 may obtain 3D depth data (including 3D integrated depth data depending on the embodiments) for the first key frame image KF 1.

Also, the application 111 may perform first 3D information restoration deep learning based on the obtained 3D depth data.

Through the operation above, the application 111 may obtain a 3D definition model based on the first key frame image KF 1.

Also, in the embodiment, the application 111 may register (store) and manage the obtained 3D definition model on a track library.

Also, in the embodiment, the application 111 may perform object tracking based on the obtained 3D definition model S603.

Specifically, in the embodiment, the application 111 may execute object tracking based on the 3D definition model (in what follows, 3D target model) for the target object TO obtained from the first key frame image KF 1.

Here, object tracking according to the embodiment may mean a functional operation that tracks changes in the 6 DoF parameters of the target object TO within predetermined image data (captured image).

Specifically, in the embodiment, the application 111 may provide a track library that provides at least one 3D definition model.

Also, the application 111 may provide a user interface (in what follows, target object environment setting interface) through which the user may select at least one of at least one 3D definition model provided through the track library.

The application 111 may read and download a 3D definition model (here, a 3D target model) selected according to user input based on the target object environment setting interface.

Thus, the application 111 may build an object tracking environment based on the 3D target model.

To continue the description, in the embodiment, the application 111 may obtain a new captured image NI obtained by capturing a predetermined 3D space from a predetermined viewpoint in conjunction with the image sensor 161.

Also, in the embodiment, the application 111 may detect the target object TO in the new captured image NI based on the 3D target model.

At this time, the application 111 may detect an object corresponding to the 3D target model among at least one object included in the new captured image NI as the target object TO.

Also, the application 111 may perform object tracking that tracks changes in the 6 DoF parameters of a detected target object TO based on the 3D target model.

Also, in the embodiment, the application 111 may provide an object additional shooting guide S605.

Here, the object additional shooting guide according to the embodiment may mean the information that describes a method for shooting the remaining area (in what follows, occlusion area OA) except for the target object TO area (in what follows, sight area) detected based on the first viewpoint.

In other words, the application 111 may provide an object additional shooting guide that guides a method for shooting a hidden area except for the sight area that may be checked through the first key frame image KF 1 captured from the first viewpoint.

In the embodiment, the object additional shooting guide may be implemented based on a predetermined voice, graphic images, and/or haptic data.

Specifically, in the embodiment, the additional object shooting guide may include information that guides shooting of the target object TO within a predetermined radius r based on the target object TO.

Also, the additional object shooting guide may further include information that guides shooting of the target object TO according to a plurality of different, consecutive viewpoints.

In other words, the object additional shooting guide according to the embodiment may include the information that guides obtaining of a plurality of image data (in what follows, a plurality of frame images) obtained by capturing the target object TO from a plurality of different, consecutive viewpoints in the area within a predetermined radius r based on the target object TO.

In the embodiment, the object additional shooting guide may be the information (in what follows, camera moving information) that describes positioning of the image sensor 161 for shooting the surroundings of the target object TO in one-take within a predetermined radius r based on the target object TO.

Alternatively, in the embodiment, the object additional shooting guide may be the information (in what follows, target object moving information) that describes the pose of the target object TO for shooting the surroundings of the target object TO in one-take within a predetermined radius r based on the target object TO.

For example, the additional object shooting guide may include target object moving information that guides the pose of the target object TO obtained when the target object (TO) is rotated 360 degrees around a predetermined direction.

Also, in the embodiment, the object additional shooting guide may further include information that provides a predetermined notification when at least part of the target object TO area disappears from the obtained frame image (i.e., at least part of the target object TO moves outside the captured image).

In the embodiment, by providing the object additional shooting guide, the application 111 may guide obtaining of a plurality of frame images that clearly include the information on the occlusion area OA of the target object TO.

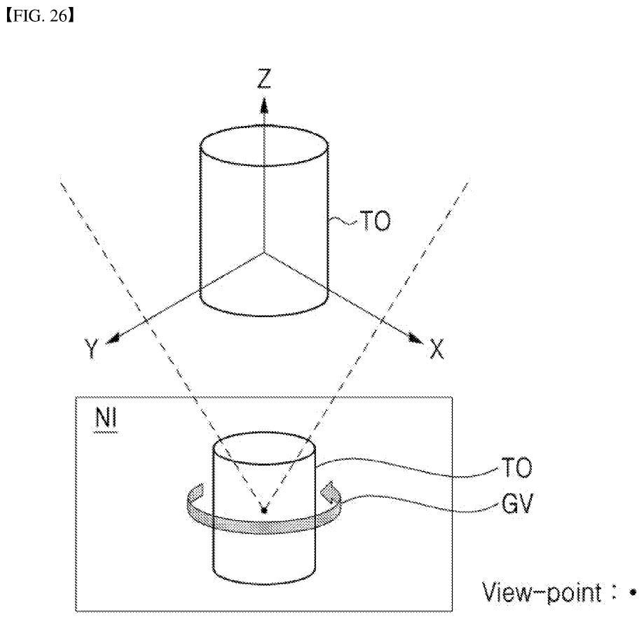

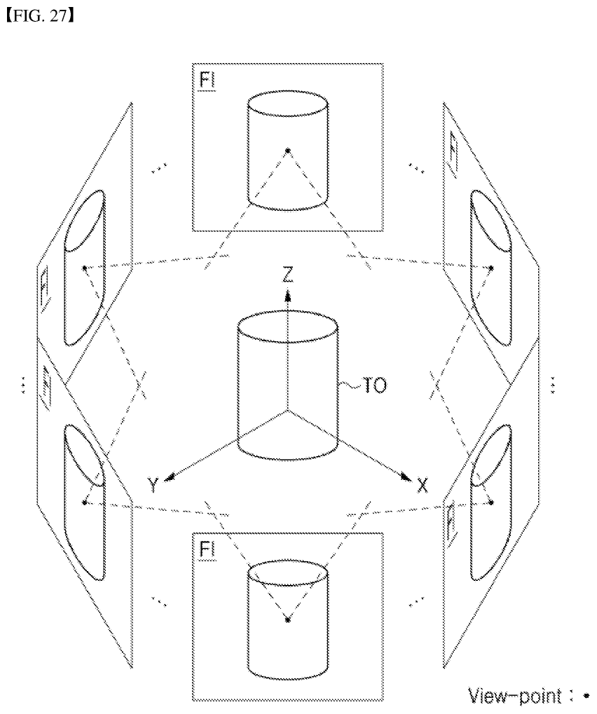

FIG. 26 is an exemplary drawing illustrating a guide virtual object according to an embodiment of the present disclosure.

At this time, depending on the embodiments, the application 111 may provide an additional object shooting guide based on a predetermined virtual object.

Specifically, in the embodiment, the application 111 may augment and display a predetermined virtual object GV (in what follows, a guide virtual object) representing camera moving information and/or target object moving information on the new captured image NI.

More specifically, in the embodiment, the application 111 may augment and display a guide virtual object GV that visually displays the change in position of the image sensor 161 according to camera moving information on the new captured image NI.

For example, the application 111 may augment and display a predetermined arrow virtual object on the new captured image NI, which sequentially follows the consecutive position coordinates of the image sensor 161 over time according to camera moving information.

Also, the application 111 may augment and display a guide virtual object GV on the new captured image NI, which visually displays the change in posture of the target object TO according to the target object moving information.

For example, the application 111 may augment and display a predetermined arrow virtual object on the new captured image NI, which guides the rotation direction of the target object TO according to the target object moving information.

As described above, by providing an object additional shooting guide based on a predetermined virtual object, the application 111 may enable a user to understand and recognize camera moving information and/or target object moving information more intuitively.

Also, through the operation above, the application 111 may help the user more reliably perform changing of the camera position and/or pose of the target object TO for obtaining a plurality of frame images.

Also, in the embodiment, the application 111 may obtain a plurality of frame images S607.

FIG. 27 is an exemplary drawing illustrating a plurality of frame images according to an embodiment of the present disclosure.

In other words, referring to FIG. 27, the application 111 according to the embodiment may obtain a plurality of frame images FI captured according to the object additional shooting guide while maintaining object tracking based on a 3D target model.

At this time, in the embodiment, the plurality of frame images FI may include 6 DoF parameters between a plurality of viewpoints from which a plurality of frame images FI are captured.

Through the operation above, the application 111 may dynamically obtain descriptors and/or distance values for the occlusion area OA of the target object TO based on the descriptors according to the 3D target model.

Also, in the embodiment, the application 111 may extract descriptors within the plurality of frame images FI obtained S609.

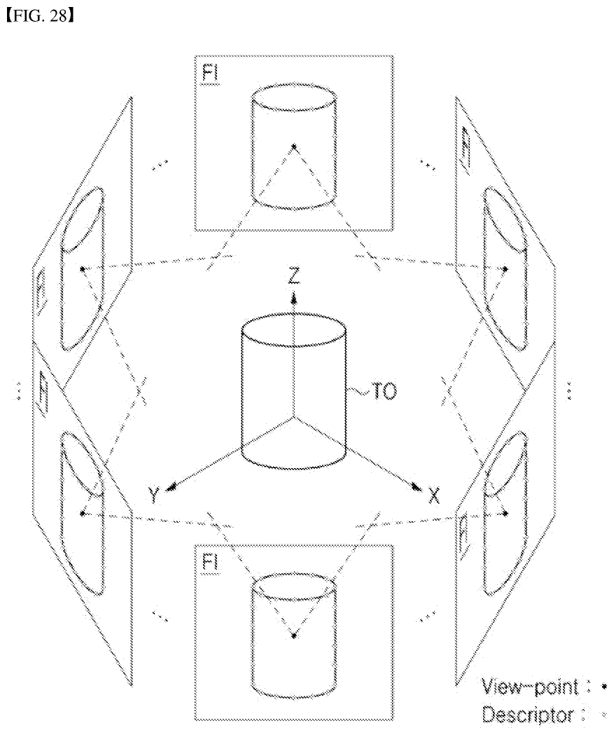

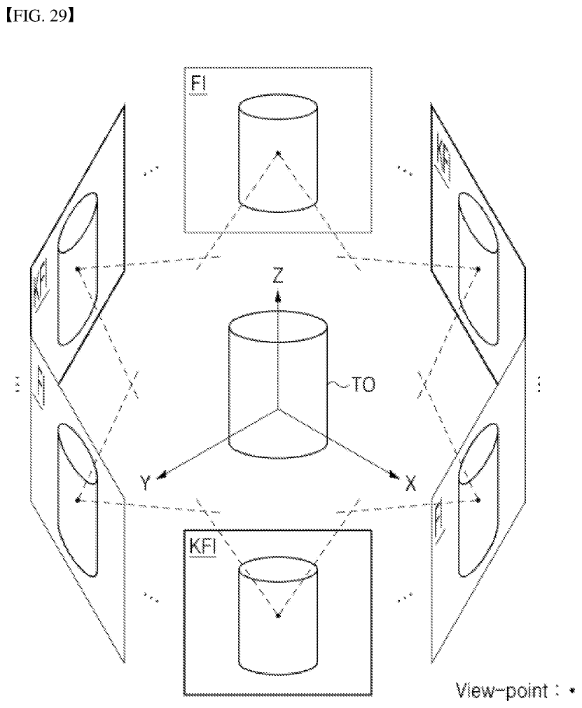

FIG. 28 is an exemplary drawing illustrating descriptors within a plurality of frame images FI according to an embodiment of the present disclosure.

Specifically, referring to FIG. 28, the application 111 according to the embodiment may obtain descriptor information (in what follows, frame descriptor information) included in each frame image FI based on a 3D target model.

More specifically, in the embodiment, the application 111 may obtain a plurality of frame descriptor information based on 6 DoF parameters between the 3D depth data included in the 3D target model (i.e., each descriptor for a target object TO from a first viewpoint and a distance value corresponding to the descriptor) and a plurality of viewpoints included in a plurality of frame images FI.

In other words, the application 111 may obtain frame descriptor information for each of the plurality of frame images FI by implementing object tracking based on the 3D target model.

At this time, in the embodiment, the application 111 may calculate the number of detections for each descriptor included in the plurality of frame descriptor information.

In other words, the application 111 may calculate the number of times each descriptor in the plurality of frame descriptor information is detected on the plurality of frame images FI.

Specifically, in the embodiment, the application 111 may obtain the position coordinates for at least one descriptor (in what follows, sub-descriptor) within each frame descriptor information.

Also, the application 111 may detect a descriptor (in what follows, the same descriptor) that specifies the same area with respect to the target object TO based on the obtained position coordinates for each sub-descriptor.

More specifically, the application 111 may detect at least one descriptor having the same position coordinates as the same descriptor among sub-descriptors included in a plurality of frame descriptor information.

Also, the application 111 may calculate the number of the same descriptors detected (in other words, the number of detections of the same descriptor).

In other words, the application 111 may determine how many times the same descriptor is detected on the plurality of frame images FI.

Also, in the embodiment, the application 111 may set invalid descriptors based on the number of detections calculated.

Here, the invalid descriptor according to the embodiment may mean the same descriptor detected fewer times than or equal to a predetermined criterion (e.g., a preconfigured value).

In other words, an invalid descriptor may be a descriptor wherein the amount of information providing valid data is less than a predetermined criterion when performing tracking based on a target object TO.

For example, the invalid descriptor may be the same descriptor detected only in one frame image FI (i.e., the number of detections is one) captured from a specific viewpoint.

Also, in the embodiment, the application 111 may remove a set invalid descriptor from the frame descriptor information.

In other words, the application 111 may remove the set invalid descriptors from learning data.

Through the operation above, the application 111 may filter and select descriptors that provide valid information above a predetermined criterion when performing target object TO-based tracking and thus improve tracking reliability and accuracy.

Also, through the operation, the application 111 may significantly reduce the computational complexity and the amount of data processing required for target object TO-based tracking.

Also, in the embodiment, the application 111 may determine a key frame image based on the extracted descriptors S611.

FIG. 29 is an exemplary drawing illustrating a key frame image according to an embodiment of the present disclosure.

Here, referring to FIG. 29, the key frame image KFI according to the embodiment may mean the image data deemed to include a relatively large amount of valid data for tracking based on a target object TO among a plurality of image data obtained by capturing the target object TO.

In the embodiment, the key frame image KFI may include a first key frame image KF 1 obtained by capturing the target object TO from the first viewpoint.

Also, the key frame image KFI may include at least one or more frame images (in what follows, key frame additional image) determined to contain a relatively large amount of valid data for target object TO-based tracking among a plurality of frame images FI.

Specifically, in the embodiment, the application 111 may detect at least one or more key frame additional image based on a plurality of frame descriptor information (in what follows, a plurality of selected descriptor information) from which invalid descriptors have been removed.

More specifically, in the embodiment, the application 111 may list a plurality of selected descriptor information corresponding to each of a plurality of frame images FI according to the time (order) at which each of the plurality of frame images FI is captured.

Also, among a plurality of selected descriptor information listed, the application 111 may detect at least one sub-descriptor (in what follows, a first sub-descriptor group) included in the predetermined first selected descriptor information (in what follows, first criterion descriptor information).

Also, among a plurality of selected descriptor information listed, the application 111 may detect at least one sub-descriptor (in what follows, a second sub-descriptor group) included in the second selected descriptor information (in what follows, first new descriptor information) obtained sequentially after the first criterion descriptor information.

Also, the application 111 may calculate the number of sub-descriptors within the first sub-descriptor group (in what follows, the number of first sub-descriptors) and the number of sub-descriptors within the second sub-descriptor group (in what follows, the number of second sub-descriptors).

Also, the application 111 may determine whether to set a frame image corresponding to the first new descriptor information (in what follows, a first new frame image) as a key frame additional image based on the number of sub-descriptors and the number of second sub-descriptors.

In other words, the application 111 may determine whether to set the current frame image as a key frame additional image based on the number of descriptors (in the embodiment, the number of first sub-descriptors) within a previous frame image (in what follows, the first criterion frame image) and the number of descriptors (in the embodiment, the number of second sub-descriptors) within the current frame image (in the embodiment, the first new frame image).

In the embodiment, when the number of second sub-descriptors compared to the number of first sub-descriptors is greater than a preset number, the application 111 may set the first new frame image as an additional key frame image.

In another embodiment, the application 111 may set the first new frame image as a key frame additional image when the number of second sub-descriptors compared to the number of first sub-descriptors is greater than a preset ratio (%).

At this time, the application 111 may repeatedly perform the process for determining a key frame additional image described above for all of the plurality of selected descriptor information listed.

In other words, in the embodiment, the application 111 may set the first new frame image as the second criterion frame image after determining whether to set a key frame additional image for the first new frame image.

Then, the application 111 may set the frame image FI obtained sequentially after the first new frame image as a second new frame image.

The application 111 may repeatedly perform the process for determining a key frame additional image based on the newly set second criterion frame image and the second new frame image.

Accordingly, the application 111 may detect at least one additional key frame image based on a plurality of selected descriptor information.

Also, the application 111 may determine at least one or more additional key frame images detected as key frame images KFI.

In other words, the application 111 may obtain a key frame image KFI including the first key frame image KF 1 and at least one or more additional key frame images.

As described above, the application 111 may select a frame image FI with more meaningful descriptors than a predetermined criterion compared to a previous frame image and determine the selected frame image as a key frame image KFI.

Therefore, the application 111 may detect a key frame image KFI containing a relatively higher quantity of valid data for target object TO-based tracking among a plurality of image data capturing the target object TO using objective numerical data.

At this time, depending on the embodiments, the application 111 may implement the first reference descriptor information based on a plurality of selected descriptor information.

In other words, the application 111 may determine whether the number of descriptors in the current frame image is greater than a predetermined criterion compared to the number of descriptors in a predetermined number (x>1) of previous frame images (e.g., three consecutive previous frame images).

Also, the application 111 may determine the current frame image as a key frame image KFI according to the result of the determination.

Therefore, the application 111 may determine the key frame image KFI based on objective data more precisely calculated and thereby improve the quality of the determined key frame image KFI.

Meanwhile, the application 111 according to the embodiment of the present disclosure may perform the processes according to steps S603 to S611 in parallel.

In other words, the application 111 according to the embodiment may extract selected descriptor information based on a plurality of frame images FI obtained, and determine a key frame image KFI according to the selected descriptor information extracted during the process of executing object tracking based on a 3D target model and obtaining a plurality of frame images FI (S603 to S607 steps).

Therefore, the application 111 may quickly and efficiently obtain additional learning data for target object TO-based tracking.

Also, in the embodiment, the application 111 may obtain 3D depth data based on the determined key frame image KFI S613.

Specifically, in the embodiment, the application 111 may perform a process according to the first embodiment (the 3D depth data calculation process based on a primitive model) and/or the second embodiment (the 3D depth data calculation process based on a deep learning neural network) described based on the determined first key frame image KF 1.

Accordingly, the application 111 may obtain 3D depth data (including 3D integrated depth data depending on the embodiments) for each key frame image KFI.

Also, in the embodiment, the application 111 may perform a 3D definition model update based on the obtained 3D depth data S615.

In other words, in the embodiment, the application 111 may update the 3D target model based on a plurality of 3D depth data obtained for each key frame image KFI.

Specifically, in the embodiment, the application 111 may perform first 3D information restoration deep learning based on each of a plurality of 3D depth data.

Here, in other words, the first 3D information restoration deep learning according to the embodiment may refer to the deep learning which uses predetermined 3D depth data as input data and a 3D definition model based on the input 3D depth data as output data.

In other words, the application 111 may generate a plurality of 3D definition models based on a plurality of 3D depth data.

Also, the application 111 may combine a plurality of 3D definition models into one 3D definition model according to a preconfigured method.

In what follows, for the purpose of effective description, a plurality of 3D definition models are limited to a first 3D definition model and a second 3D definition model; however, the present disclosure is not limited to the specific example.

In the embodiment, the application 111 may detect descriptors having mutually corresponding position coordinates (in what follows, common descriptors) among a plurality of descriptors within the first 3D definition model and a plurality of descriptors within the second 3D definition model.

Also, the application 111 may detect a distance value corresponding to a common descriptor within the first 3D definition model (in what follows, a first distance value).

Also, the application 111 may detect a distance value corresponding to a common descriptor within the second 3D definition model (in what follows, a second distance value).

Also, the application 111 may obtain an integrated distance value obtained by combining the detected first and second distance values into a single value according to a preconfigured method (e.g., predetermined arithmetic operations performed by reflecting the 6 DoF parameters between viewpoints from which the first 3D definition model and the second 3D definition model are captured, respectively).

Also, the application may set the obtained integrated distance value as a distance value of the common descriptor.

Also, in the embodiment, the application 111 may detect and obtain the remaining descriptors excluding the common descriptor (in what follows, specialized descriptors) from among a plurality of descriptors within the first 3D definition model and a plurality of descriptors within the second 3D definition model.

Also, in the embodiment, the application 111 may generate 3D integrated definition model which includes both the common descriptor and the specialized descriptor obtained.

Therefore, the application 111 may combine the first 3D definition model and the second 3D definition model into one 3D definition model.

However, the embodiment described above is only an example, and the embodiment of the present disclosure does not specify or limit the method itself, which combines a plurality of 3D definition models into one 3D definition model.

Also, the application 111 may set a 3D definition model (in what follows, a 3D integrated model) which combines a plurality of 3D definition models as a 3D target model.

In other words, the application 111 may change (update) the 3D target model, which is a 3D definition model for the target object TO, into a 3D integrated model.

In another embodiment, the application 111 may perform second 3D information restoration deep learning based on a plurality of 3D depth data.

Here, in other words, the second 3D information restoration deep learning according to the embodiment may refer to the deep learning using a plurality of 3D depth data as input data and a single 3D definition model based on the plurality of 3D depth data as output data.

In other words, in the embodiment, the application 111 may perform the second 3D information restoration deep learning based on the plurality of 3D depth data and obtain a 3D integrated model which combines the plurality of 3D depth data into single 3D depth data.

Also, the application 111 may change (update) a 3D target model into the 3D integrated model obtained.

As described above, by generating and providing a 3D definition model for a target object TO (in the embodiment, a 3D target model) based on a plurality of image data obtained by capturing the target object TO from various viewpoints, the application 111 may implement an accurate tracking process based on the target object TO even if the target object TO is captured from an arbitrary viewpoint.

Also, through the operation above, the application 111 may solve the problem of tracking quality degradation due to the occlusion area OA of the target object TO by minimizing the occlusion area OA of the target object TO.

At this time, according to the embodiments, the application 111 may register (store) and manage the updated 3D target model on a track library.

Also, in the embodiment, the application 111 may perform AR object tracking based on the updated 3D definition model S617.

In other words, in the embodiment, the application 111 may perform AR object tracking based on the updated 3D target model (i.e., the 3D integrated model in the embodiment).

Here, referring further to FIG. 23, in other words, the AR object tracking according to the embodiment may mean a function operation that tracks changes in the 6 DoF parameters of a virtual object augmented and displayed on predetermined image data (shooted videos).

Specifically, in the embodiment, the application 111 may generate an AR environment model based on the 3D integrated model.

Here, referring further to FIG. 22, in other words, the AR environment model EM according to the embodiment may mean a model that includes a predetermined 3D definition model DM and a predetermined virtual object VO anchored to the predetermined 3D definition model DM.

More specifically, the application 111 according to the embodiment may determine a target virtual object to be augmented and displayed based on a 3D integrated model.

Also, the application may perform anchoring between the determined target virtual object and the 3D integrated model.

Here, in other words, anchoring according to the embodiment may mean a functional operation for registering a target criterion object to a target virtual object so that the changes in the 6 DoF parameters of the target criterion object are reflected in the changes in the 6 DoF parameters of the target virtual object.

Thus, the application 111 may generate an AR environment model EM which includes a 3D integrated model and a target virtual object anchored to the 3D integrated model.

Also, in the embodiment, the application 111 may register (store) and manage the created AR environment model EM on the AR environment library.

Afterward, in the embodiment, the application 111 may provide an AR environment library that provides at least one AR environment model EM.

Specifically, the application 111 may provide an AR environment setting interface through which a user may select at least one from among at least one AR environment model EM provided through the AR environment library.

Also, in the embodiment, the application 111 may read and download an AR environment model EM (in the embodiment, the first AR environment model) selected according to user input through the AR environment setting interface.

Thus, the application may build an AR object tracking environment based on the first AR environment model.

To continue the description, in the embodiment, the application 111 may obtain a new captured image NI obtained by capturing a predetermined 3D space from a predetermined viewpoint in conjunction with the image sensor 161.

Also, in the embodiment, the application 111 may detect a target object (in the embodiment, a first tracking object) within the new captured image NI based on the first AR environment model.

At this time, the application 111 may detect an object corresponding to a target criterion object of the first AR environment model (in the embodiment, a first target criterion object) among at least one object included in the new captured image NI as a first tracking object.

Also, in the embodiment, the application 111 may augment and display a predetermined virtual object VO on the new captured image NI based on the first AR environment model.

Specifically, the application 111 may augment and display the target virtual object (in the embodiment, the first target virtual object) of the first AR environment model on the new captured image NI.

At this time, the application 111 may augment and display the first target virtual object on the new captured image NI based on the anchoring information between the first target criterion object and the first target virtual object of the first AR environment model.

Specifically, according to the anchoring information between the first target criterion object and the first target virtual object of the first AR environment model, the application 111 may augment and display the first target virtual object at a predetermined position based on the first tracking object within the new captured image NI.

In other words, the application 111 may augment and display a first virtual object at a position where anchoring information between a first target criterion object and a first target virtual object within the first AR environment model and anchoring information between a first tracking object and a first target virtual object within the new captured image NI are implemented in the same manner.

Therefore, provided that the user constructs an AR environment model EM for a desired target object on the user's working environment, the application 111 may detect the target object within a specific captured image, track changes in the 6 DoF parameters of the detected target object TO and each virtual object anchored to the target object according to a preconfigured method, and display the target object and the virtual object using a shape corresponding to the tracked changes in the 6 DoF parameters. As described above, the method and the system for providing an AR object based on an identification code according to an embodiment of the present disclosure provide a working environment in which a user may author an AR object registered with greater accuracy to a predetermined actual object, thereby providing an effect of delivering a more seamless augmented display by harmonizing the authored AR object with the predetermined actual object based on a predetermined identification code.

Also, the method and the system for providing an AR object based on an identification code according to an embodiment of the present disclosure provide a predetermined Augmented Reality (AR) object through the web environment based on a predetermined identification code; therefore, the application 111 may provide an augmented reality environment easily and conveniently through the web once a predetermined identification code is recognized, without involving environmental factors for implementing the augmented reality environment (e.g., installation of a separate software program).

Meanwhile, the embodiments of the present disclosure descried above may be implemented in the form of program commands which may be executed through various constituting elements of a computer and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; magneto-optical media such as floptical disks; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be configured to be operated by one or more software modules to perform the operations of the present disclosure, and vice versa.

Specific implementation of the present disclosure are embodiments, which does not limit the technical scope of the present disclosure in any way. For the clarity of the specification, descriptions of conventional electronic structures, control systems, software, and other functional aspects of the systems may be omitted. Also, connection of lines between constituting elements shown in the figure or connecting members illustrates functional connections and/or physical or circuit connections, which may be replaceable in an actual device or represented by additional, various functional, physical, or circuit connection. Also, if not explicitly stated otherwise, “essential” or “important” elements may not necessarily refer to constituting elements needed for application of the present disclosure.

Also, although detailed descriptions of the present disclosure have been given with reference to preferred embodiments of the present disclosure, it should be understood by those skilled in the corresponding technical field or by those having common knowledge in the corresponding technical field that the present disclosure may be modified and changed in various ways without departing from the technical principles and scope specified in the appended claims. Therefore, the technical scope of the present disclosure is not limited to the specifications provided in the detailed descriptions of this document but has to be defined by the appended claims.

What is claimed is:

1. A method for providing an AR object based on an identification code by a tracking application executed by at least one processor of a terminal, the method comprising:
generating an AR library, which is a data set providing a predetermined augmented reality environment, based on at least one or more target objects;
storing the AR library by matching the AR library to a first target object and a second target object; and
providing an augmented reality environment based on the second target object and the AR library matched to the first target object when being connected to the web environment based on the first target object,
wherein providing an augmented reality environment comprises:
obtaining a first image capturing the first target object through an image sensor of the terminal,
detecting the first target object based on the obtained first image,
obtaining an augmented reality web environment access link for providing the AR library matched to the detected first target object,
obtaining a second image capturing the second target object through an image sensor of the terminal in the augmented reality environment accessed through the obtained link,
detecting a second target object based on the obtained second image, and
controlling a first virtual object included in the AR library to be augmented and displayed on the detected second target object.

2. The method of claim 1, wherein the storing of the AR library by matching to the first target object includes generating a link providing a Uniform Resource Locator (URL) linked to the augmented reality environment and
storing the link by matching the link to the first target object.

3. The method of claim 2, wherein the obtaining of the augmented reality web environment access link for providing the AR library includes capturing a first identification code image representing the first target object and recognizing the link matched to the first target object.

4. The method of claim 3, wherein the capturing of the first identification code image includes capturing the first identification code image implemented as at least one of a graphic identification code that represents the first target object in the form of a graphic image and a real identification code that prints the actual shape of the first target object.

5. The method of claim 1, wherein the obtaining of the second image capturing the second target object includes capturing the second target object which is an object that the first target object is attached or an object that exists separately from the first target object.

6. The method of claim 1, wherein the obtaining of the first image and the second image includes capturing the first target object and the second target object which are implemented as at least one of a 2D identification code, a 2D image and a 3D object.

7. The method of claim 1, wherein the providing of the augmented reality web environment includes determining 6 degrees of freedom and scale parameters of the at least one or more target objects and the first virtual object according to the change of a viewpoint from which the first image and the second image are captured.

8. The method of claim 1, wherein the storing the AR library by matching the AR library to the first target object includes generating a link providing a Uniform Resource Locator (URL) linked to the augmented reality environment and setting a short-range wireless communication medium for transmitting the link through short-range wireless communication.

9. The method of claim 8, wherein the obtaining of the augmented reality web environment access link for providing the AR library includes receiving the link from the set short-range wireless communication medium through short-range wireless communication.

10. The method of claim 8, wherein the setting of the short-range wireless communication medium includes recognizing the short-range wireless communication medium and recording to distribute the link over the recognized short-range wireless communication medium or
displaying short-range wireless communication devices installed at a plurality of places on a map and setting up to distribute the link on at least one of the displayed short-range wireless communication devices.

11. The method of claim 1, wherein the generating of the AR library includes generating an AR project providing an AR library authoring interface and generating the AR library based on the AR library authoring interface of the generated AR project.

12. The method of claim 11, wherein the generating of the AR library based on the AR library authoring interface includes generating anchoring information determining 6 degrees of freedom and scale parameters of the first virtual object according to the change of the 6 degrees of freedom and scale parameters of the at least one or more target objects.

13. The method of claim 11, wherein the generating of the AR library based on the AR library authoring interface includes generating interaction information determining a predetermined event functional operation generated according to user input based on at least one or more target objects or the first virtual object.

14. A system for providing an AR object based on an identification code comprising:
at least one memory storing a tracking application; and
at least one processor implementing a method for providing an AR object based on an identification code by reading the tracking application stored in the memory,
wherein commands of the tracking application include commands for performing: generating an AR library, which is a data set providing a predetermined augmented reality environment, based on at least one or more target objects,
storing the AR library by matching the AR library to a first target and a second target object, and
providing an augmented reality environment based on the second target and the AR library matched to the first target object when being connected to the web environment based on the first target object,
wherein providing an augmented reality environment comprises:
obtaining a first image capturing the first target object through an image sensor of the terminal,
detecting the first target object based on the obtained first image,
obtaining an augmented reality web environment access link for providing the AR library matched to the detected first target object,
obtaining a second image capturing the second target object through an image sensor of the terminal in the augmented reality environment accessed through the obtained link,
detecting a second target object based on the obtained second image, and
controlling a first virtual object included in the AR library to be augmented and displayed on the detected second target object.
